(19) United States
(12) Patent Application Publication
(10) Pub. No.: US 2007/0014551 A1
(43) Pub. Date: Jan. 18, 2007

(54) Image sensing apparatus, imaging system, and operation program product therefor

(75) Inventors: Toshiki Fujisawa, Osaka-shi (JP); Atsutaka Ito, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/349,316

(22) Filed: Feb. 7, 2006

(30) Foreign Application Priority Data
Jul. 13, 2005 (JP) 2005-204866

(51) Int. Cl. G03B 37/02

(52) U.S. Cl. 396/20

(57) ABSTRACT

An image sensing apparatus has: an image sensor which converts a subject optical image into an electrical signal; a driving section which moves the image sensor on a plane orthogonal to an optical axis of the image sensing apparatus: an imaging controlling section which causes the image sensor to obtain at least a first image and a second image sequentially, wherein the first image is obtained by causing the image sensor to perform an image capturing operation with the image sensor being located at a first position, and the second image is obtained by causing the image sensor to perform an image capturing operation with the image sensor being located at a second position different from the first position by driving of the driving section; and a storage which stores the first image and the second image in correlation to each other so that a composite image is creatable by joining the first image and the second image.

This application is based on Japanese Patent Application No. 2005-204866 filed on Jul. 13, 2005, the contents of which are hereby incorporated by reference.

### BACKGROUND OF THE INVENTION

1. Field of the Invention

The present invention relates to an image sensing apparatus provided with an image sensor such as a charge coupled device (CCD) image sensor, and particularly to an image sensing apparatus for sensing plural images by moving the image sensor on a plane orthogonal to an optical axis of the image sensing apparatus for synthesis of the images, an imaging system, and an operation program product therefor.

2. Description of the Related Art

Generally, an image photographing area of a digital camera is determined by an optical design of a photographing optical system, the size of an image sensor, or the like. There is, however, a demand for a digital camera capable of acquiring an image of an area larger than a photographing area inherent to the camera. For instance, Japanese Unexamined Patent Publication No. 7-128582 (hereinafter, called as “Document D1”) discloses an arrangement to satisfy such a demand, in which a shift lens is incorporated in a photographing optical system, and a photographing area is changed by moving the shift lens on a plane orthogonal to the optical axis of the photographing optical system. Also, Japanese Unexamined Patent Publication No. 2003-60967 (hereinafter, called as “Document D2”) discloses an arrangement, in which an image shifting mechanism is provided to shift a lens group constituting a photographing optical system in a yaw direction and in a pitch direction by an actuator, an image capturing operation is performed a number of times, with an image to be formed on the image sensor being displaced one from another by the image shifting mechanism, and one image with an expanded angle of view is created by synthesizing the images obtained by the image capturing operations.

The arrangements as disclosed in Documents D1 and D2, in which part of the lens elements constituting the photographing optical system is moved to shift or expand the photographing area, require the shift lens or the image shifting mechanism depending on the kind of the photographing optical system to be loaded, particularly on the size of the image circle. In particular, in a case that a lens-exchangeable digital camera such as a single lens reflex camera is used, a user has to purchase a shift lens as an optional part in accordance with the kind of the interchangeable lens to be loaded on the camera. Also, an influence of lens aberration may be considered in light of the fact that the shift lens or the image shifting mechanism is provided in the photographing optical system.

### SUMMARY OF THE INVENTION

In view of the problems residing in the prior art, it is an object of the present invention to provide an image sensing apparatus, an imaging system, and an operation program product which are free from the problems residing in the prior art.

It is another object of the present invention to provide an image sensing apparatus that enables to change a photographing area irrespective of the kind of a photographing optical system to be loaded or mounted on the image sensing apparatus, and to easily synthesize plural images acquired by image capturing operations without an influence of lens aberration, as well as an imaging system, and an operation program therefor.

An aspect of the invention is directed to an image sensing apparatus comprising: an image sensor which converts a subject optical image into an electrical signal; a driving section which moves the image sensor on a plane orthogonal to an optical axis of the image sensing apparatus: an imaging controlling section which causes the image sensor to obtain at least a first image and a second image sequentially, the first image being obtained by causing the image sensor to perform an image capturing operation with the image sensor being located at a first position, and the second image being obtained by causing the image sensor to perform an image capturing operation with the image sensor being located at a second position different from the first position by driving of the driving section; and a storage which stores the first image and the second image in correlation to each other so that a composite image is creatable by joining the first image and the second image.

These and other objects, features and advantages of the present invention will become more apparent upon reading of the following detailed description along with the accompanying drawings.

### BRIEF DESCRIPTION OF THE DRAWINGS

FIG. 1 is an external front view of a digital camera in an embodiment of the invention.

FIG. 2 is an external rear view of the digital camera in the embodiment of the invention.

FIG. 3 is a cross-sectional view showing an internal arrangement of the digital camera in the embodiment of the invention.

FIGS. 4A and 4B are illustrations showing an arrangement of a driving mechanism for supporting and driving an image sensor, wherein FIG. 4A is a rear view of the driving mechanism viewed from a side opposite to an imaging plane of the image sensor, and FIG. 4B is a side view of the driving mechanism in the direction of the arrow B in FIG. 4A.

FIGS. 5A and 5B are illustrations showing an arrangement of an actuator, wherein FIG. 5A is an exploded perspective view of the actuator, and FIG. 5B is a perspective view of the actuator in an assembled state.

FIG. 6 is a waveform diagram showing a drive pulse to be applied to a piezoelectric device constituting the actuator.

FIG. 7 is a plan view showing how the image sensor is moved by the driving mechanism.

FIG. 8 is a block diagram showing an electrical configuration of the digital camera in the embodiment of the invention.

FIG. 9 is a functional block diagram showing a functional arrangement of an area enlarge controller, which is an essential part of the digital camera in the embodiment of the invention.

FIG. 10 is an illustration showing a relation between an image circle of a photographing optical system in a lens unit, and an imaging area of the image sensor.

FIGS. 11A through 11C are illustrations showing an example as to how the imaging area is moved in a mode of manually moving the image sensor.

FIGS. 12A through 12D are illustrations showing a moving pattern of the imaging area, which is configured to create a panoramic composite image with its horizontal side in an X-axis direction longer than its vertical side.

FIGS. 13A through 13E are illustrations showing a moving pattern of the imaging area, which is configured to create a full-size composite image.

FIG. 14 is an illustration showing an example as to how images are joined to each other.

FIG. 15 is an illustration showing a manner as to how an image captured by a shift photographing operation is recorded in a memory card as an image file by an image record controlling section.

FIG. 16 is an illustration showing a relation between an image circle of a lens unit for an advanced photo system (APS), and the imaging area.

FIGS. 17A and 17B are illustrations showing a process of calculating a shift amount by a shift amount calculating section.

FIGS. 18A through 18C are illustrations showing an example of the shift photographing operation to describe a function of an image selecting section.

FIGS. 19A through 19C are illustrations showing an example of joining images to each other.

FIGS. 20A and 20B are diagrams showing a manner as to how images to be joined are automatically selected.

FIG. 21 is a flowchart showing a series of image capturing operations to be implemented by the digital camera in the embodiment of the invention.

FIG. 22 is a flowchart showing a flow of the shift photographing operation.

FIG. 23 is a timing chart showing a preferred controlling process of moving the image sensor by a continuous photograph controlling section.

FIG. 24 is a flowchart showing a flow of an image synthesizing operation.

FIG. 25 is an illustration showing an imaging system as another embodiment of the invention.

FIG. 26 is a block diagram showing a functional arrangement of the imaging system.

### DETAILED DESCRIPTION OF THE PREFERRED EMBODIMENTS OF THE INVENTION

In the following, an embodiment of the invention is described in detail referring to the drawings by taking a digital camera as an example of an image sensing apparatus embodying the invention.

(Description on Camera Structure)

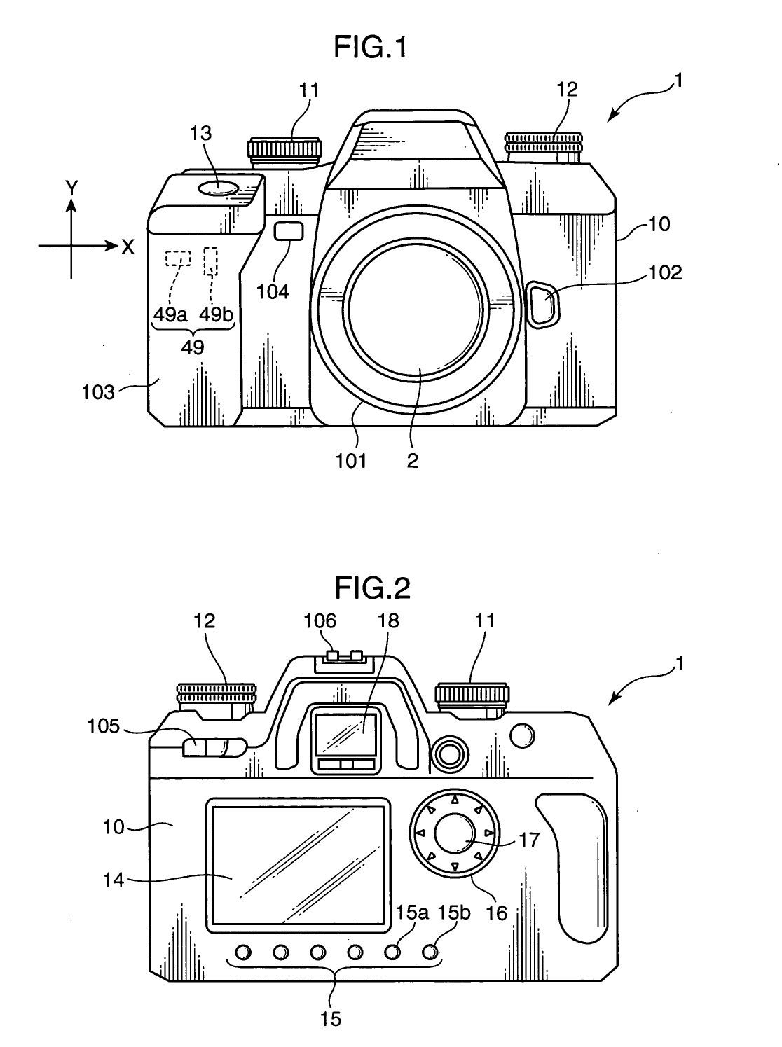

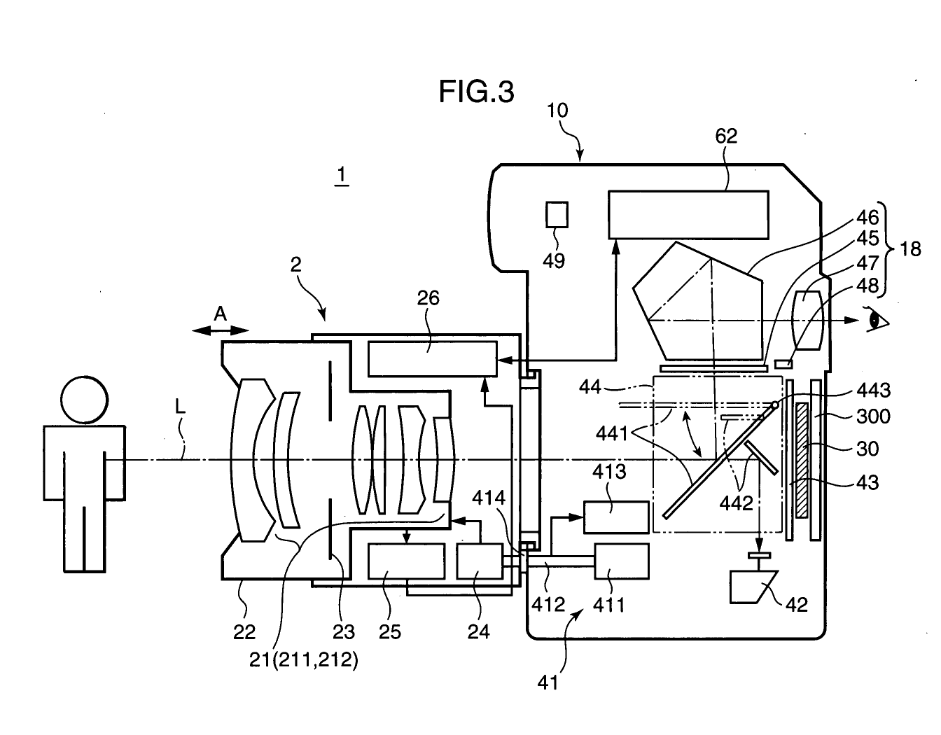

FIGS. 1 and 2 are illustrations showing an external appearance of a digital camera 1 embodying the invention. FIG. 1 is a front view of the digital camera 1, and FIG. 2 is a rear view of the digital camera 1. FIG. 3 is a cross-sectional view showing an internal arrangement of the digital camera 1. As shown in FIG. 1, the digital camera 1 is a single lens reflex camera provided with a camera body 10, and an exchangeable lens unit 2 detachably attached to a substantially middle part on a front face of the camera body 10.

In FIG. 1, the camera body 10 has, on the front face thereof, a mount portion 101 arranged at the substantially middle part for mounting the lens unit 2 thereon, a lens exchange button 102 arranged on the right of the mount portion 101, a grip portion 103 arranged on a left end portion, namely, on the left side in X-direction for allowing a user to securely grip or hold the camera 1 with his or her hand(s), a self-timer lamp 104 arranged on the left of the mount portion 101, a mode setting dial 11 arranged at a top left portion, namely, an upper left portion in Y-direction, a control value setting dial 12 arranged at a top right portion, and a shutter button 13 arranged on a top face of the grip portion 103.

Referring to FIG. 2, the camera body 10 has, on the rear face thereof, a liquid crystal display (LCD) 14 disposed on a left side, a setting button group 15 arranged below the LCD 14, a jog dial 16 arranged on a side of the LCD 14, a push button 17 arranged at a radially inner position of the jog dial 16, an optical viewfinder 18 arranged at an upper part relative to the LCD 14, a main switch 105 arranged on a side of the optical viewfinder 18, and a connecting terminal portion 106 arranged on the top part of the camera body 10 above the optical viewfinder 18.

The mode setting dial 11 and the control value setting dial 12 each has a substantially disc-like shape and is made pivotally rotatable on a plane substantially parallel to the upper face of the camera body 10. The mode setting dial 11 is adapted to select one of various modes or functions loaded in the digital camera 1 such as an automatic exposure (AE) control mode, an automatic focusing (AF) control mode, various photographing modes including a still image photographing mode of photographing a still image, and a continuous photographing mode of sequentially photographing images, and a mode of playing back recorded images. The control value setting dial 12 is adapted to set control values corresponding to the various functions loaded in the digital camera 1.

The shutter button 13 is of a pressing type, and is operable in two states, namely, a halfway pressed state and a fully pressed state. When the shutter button 13 is set to the halfway pressed state in the still image photographing mode, a photographing preparatory operation of photographing a still image of a subject such as setting of an exposure control value or focus control is executed. When the shutter button 13 is set to the fully pressed state, a photographing operation, namely, a series of operations of exposing an image sensor, applying a predetermined image processing to an image signal obtained by the exposure, and recording the image signal in a memory card or the like, is executed. The halfway pressed state of the shutter button 13 is detected in response to turning on of a switch S1 (not shown), and the fully pressed state of the shutter button 13 is detected in response to turning on of a switch S2 (not shown).

The LCD 14 includes a color liquid crystal display panel. The LCD 14 is adapted to display an image captured by the image sensor 30 (see FIG. 3), to play back a recorded image, and to display a screen image for allowing the user to designate a function or a mode loaded in the digital camera 1. An organic electroluminescent device or a plasma display device may be used in place of the LCD 14.

The setting button group 15 is a group of buttons for allowing the user to designate the various functions loaded in the digital camera 1. In this embodiment, the setting button group 15 includes a selection determination switch for allowing the user to determine the contents selected on a menu screen displayed on the LCD 14, a selection cancellation switch, a menu display switch for allowing the user to switch over the contents displayed on the menu screen, a display on/off switch, a display enlargement switch, and a playback switch, as well as an anti-shake switch 15a and a shift photographing switch 15b.

The anti-shake switch 15a is a switch for allowing the user to move the image sensor 30 on a plane orthogonal to an optical axis of the lens unit 2 for cancellation of a shake exerted to the camera body 10. The shift photographing switch 15b is a switch for allowing the user to shift the center of the imaging plane of the image sensor 30 relative to the center of the optical axis of the photographing optical system, namely, the lens unit 2 for shift photographing. As will be described later in detail, in the shift photographing mode, an image capturing operation is performed in a state that the image sensor 30 is located at a first position to acquire a first image, and an image capturing operation is performed in a state that the image sensor 30 is located at a second position different from the first position to acquire a second image. The number of times of performing shift photographing operations is not limited to twice. The embodiment includes an arrangement that image capturing operations are performed, with the position of the image sensor 30 being changed three or more times in a series of shift photographing operations to acquire three or more frames of images.

The jog dial 16 includes an annular member provided with plural pressing portions indicated by triangular marks in FIG. 2 which are arrayed at a certain interval in a circumferential direction of the annular member. The jog dial 16 is constructed in such a manner that a contact or a switch (not shown) provided in association with each one of the pressing portions of the jog dial 16 detects whether the corresponding pressing portion has been manipulated. The push button 17 is arranged in the middle of the jog dial 16. With use of the jog dial 16 and the push button 17, the user is allowed to input designation regarding change of the zoom ratio by moving a zoom lens element to a wide-angle limit or to a telephoto limit, feeding of frames of recorded images to be played back on the LCD 14, setting of photographing conditions such as the aperture value, the shutter speed, firing/non-firing of flash, and the like.

The optical viewfinder 18 is adapted to optically display a photographing area of a subject image. Specifically, a subject image through the lens unit 2 is guided to the optical viewfinder 18 so that the user or the photographer can recognize the subject image to be actually captured by the image sensor 30 through the optical viewfinder 18.

The mount portion 101 is a member for mounting the lens unit 2 thereon. A plurality of electrical contacts (not shown) for electrical connection of the camera body 10 to the lens unit 2 to be mounted on the mount portion 101, and a coupler 414 (see FIG. 3), which will be described later, for mechanical connection of the camera body 10 to the lens unit 2 are provided near the mount portion 101. The lens exchange button 102 is adapted to detach the lens unit 2 from the mount portion 101 by pressing.

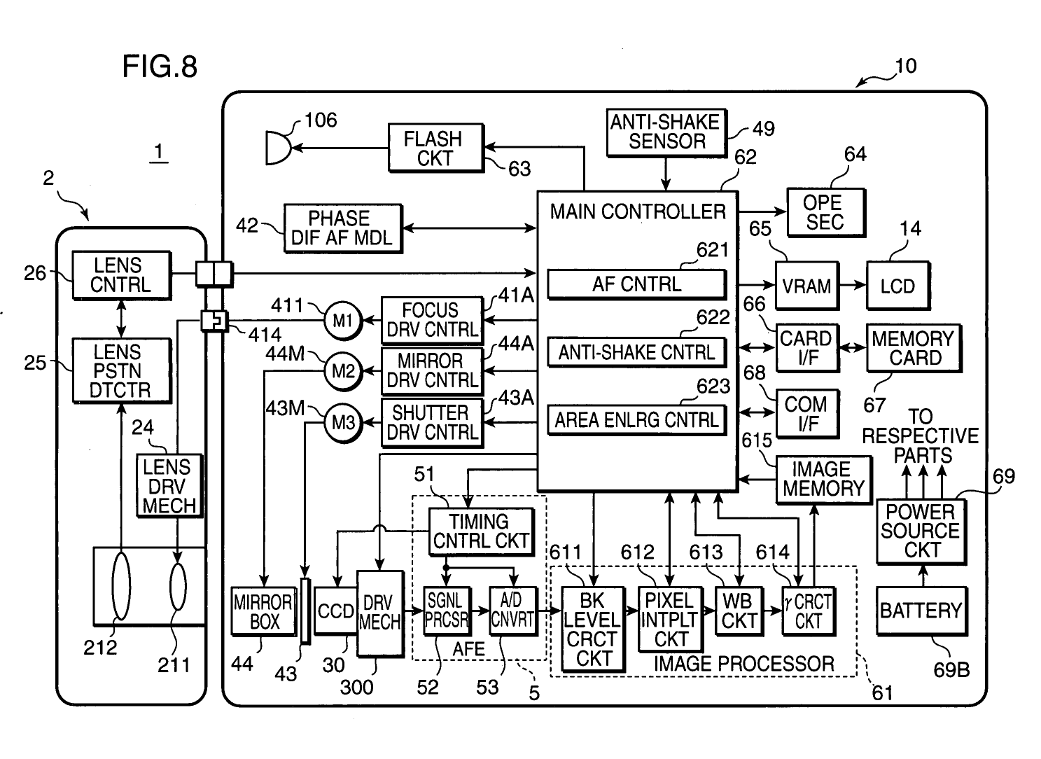

The grip portion 103 is a portion for allowing the user to grip the digital camera 1 in photographing, and is formed with a projected/recessed portion on a surface thereof to match the fingers of the user to enhance fitting. The grip portion 103 is formed therein a battery housing chamber and a card housing chamber. The battery housing chamber is designed to house a battery 69B (see FIG. 8) as a power source of the camera, and the card housing chamber is designed to detachably mount a recording medium e.g. a memory card 67 therein for recording data of photographed images.

The self-timer lamp 104 includes a light emitting device such as a light emitting diode (LED), and is adapted to emit light in self-time photographing. The main switch 105 is a two-contact slide switch which is sidable in left and right directions of the camera. When the main switch 105 is set to the left position, the power of the digital camera 1 is turned on, and when the main switch 105 is set to the right position, the power of the digital camera 1 is turned off. The connecting terminal portion 106 is a terminal for connecting the digital camera 1 to an unillustrated external device such as a flash device.

As shown by the dotted line in FIG. 1, the digital camera 1 is loaded with an anti-shake sensor 49 at an appropriate position on the camera body 10. The anti-shake sensor 49 is adapted to detect a shake exerted to the camera body 10. Assuming that there is a two dimensional coordinate system with X-axis extending in a horizontal direction of FIG. 1 and Y-axis extending perpendicularly to the X-axis, the anti-shake sensor 49 has an X-sensor 49a for detecting a shake of the camera in the X-axis direction, and a Y-sensor 49b for detecting a shake of the camera in the Y-axis direction. The X-sensor 49a (Y-sensor 49b) is constituted of a gyro provided with a piezoelectric device, for instance, to detect an angular velocity of a shake of the camera in the X-axis direction (Y-axis direction).

The lens unit 2 functions as a lens aperture for receiving an optical image of a subject, and constitutes the photographing optical system for guiding the subject optical image to the image sensor 30 and to the optical viewfinder 18 in the camera body 10. The image sensor 30 and the optical viewfinder 18 will be described later. The lens unit 2 is detachable from the camera body 10 by pressing the lens exchange button 102.

The lens unit 2 includes a lens group 21 (see FIG. 3) constituted of a plurality of lens elements arrayed linearly along the optical axis L. The lens group 21 includes a focus lens element 211 (see FIG. 8) for focus control, and the zoom lens element 212 (see FIG. 8) for zooming. Zooming and focus control are performed by moving the focus lens element 211 and the zoom lens element 212 in the optical axis direction, respectively. The lens unit 2 includes an unillustrated rotatable operation ring, which is provided at an appropriate position on an outer circumferential portion of a lens barrel 22 along the outer circumference thereof. The zoom lens element 212 is manually or automatically movable to an intended position in the optical axis direction in accordance with a rotation direction and an angular displacement of the operation ring to attain a designated zoom ratio corresponding to the intended position.

Next, an internal arrangement of the camera body 10 is described referring to FIG. 3. As shown in FIG. 3, the camera body 10 is incorporated therein the image sensor 30, a driving mechanism 300, an AF driving unit 41, a phase difference AF module 42, a shutter unit 43, a mirror box 44, the optical viewfinder 18, the anti-shake sensor 49, and a main controller 62.

The image sensor 30 is a sensor for converting a subject optical image into an electrical signal, and includes an image capturing section having photoelectric conversion elements for generating signal charges in accordance with the received light amounts, and a peripheral circuit section for controlling the image capturing section. The image sensor 30 is arranged in a region on the rear face of the camera body 10 substantially in parallel thereto. The image sensor 30 is supported by the driving mechanism 300 for drivingly moving the image sensor 30 on a plane orthogonal to the optical axis L.

The image sensor 30 is, for instance, a charge coupled device (CCD) color area sensor of a so-called “Bayer matrix” in which photoelectric conversion elements each constituted of a photodiode are arrayed two-dimensionally in a matrix, and patches of color filters in red (R), green (G), and blue (B) having different spectral characteristics from each other are attached on light receiving surfaces of the respective photoelectric conversion elements with a ratio of 1:2:1. The image sensor 30 converts an optical image of a subject formed by the photographing optical system, namely, by the lens group 21 into analog electrical signals, namely, image signals of respective color components of R, G, and B for outputting.

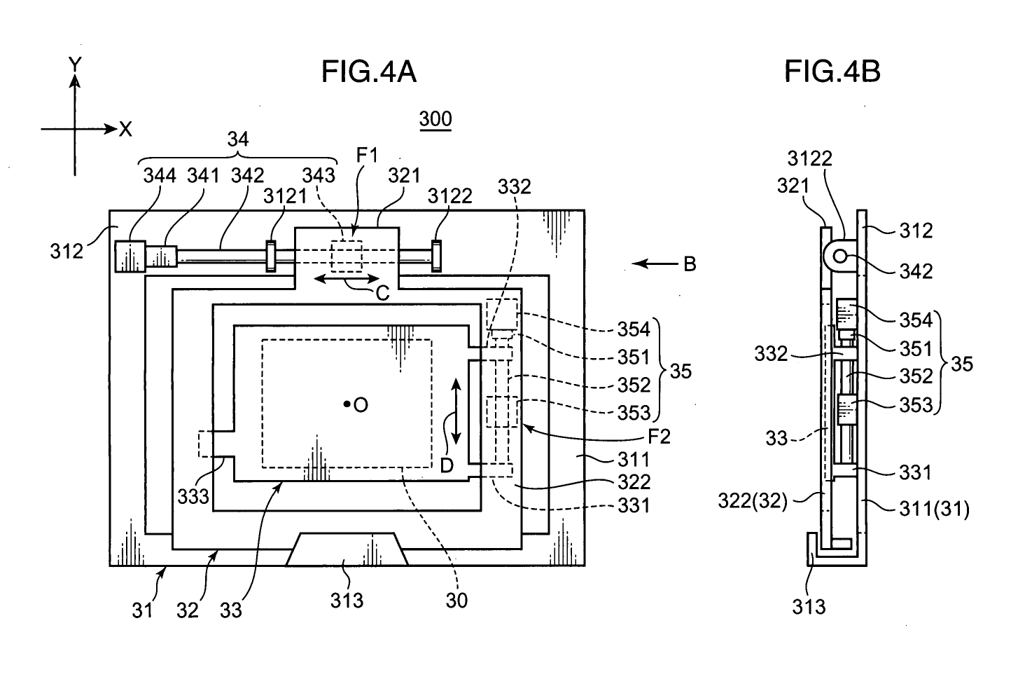

FIGS. 4A and 4B are illustrations showing the driving mechanism 300 for supporting and driving the image sensor 30. FIG. 4A is a rear view of the driving mechanism 300 viewed from the side opposite to the imaging plane of the image sensor 30, and FIG. 4B is a side view of the driving mechanism 300 in the direction of the arrow B in FIG. 4A. As shown in FIG. 4A, there is defined a two dimensional coordinate system corresponding to the two dimensional coordinate system in FIG. 1, wherein the X-axis direction is defined as a first axis direction, and the Y-axis direction is defined as a second axis direction with respect to the imaging plane of the image sensor 30.

The driving mechanism 300 for supportively moving the image sensor 30 on the plane orthogonal to the optical axis L functions as an anti-shake driving mechanism for correctively driving the image sensor t30 in response to turning on of the anti-shake switch 15a, and also functions as a shift photographing driving mechanism for moving the image sensor 30 for shift photographing in response to setting of the shift photographing mode by turning on of the shift photographing switch 15b. In other words, the driving mechanism 300 is commonly used as the anti-shake driving mechanism and the shift photographing driving mechanism.

The driving mechanism 300 has a first base plate 31, a second base plate 32, and a third base plate 33 each having a substantially rectangular shape, an X-axis actuator 34, and an Y-axis actuator 35. The first base plate 31 is secured to an appropriate position on the camera body 10, and is comprised of a frame-like member formed by eliminating a central portion of the rectangular shape except for a peripheral portion to prevent blocking of the optical path onto the image sensor 30. The first base plate 31 includes a frame-like main body 311, an X-axis actuator fixing portion 312 for fixedly mounting the X-axis actuator 34 thereon, and a guide portion 313 for guiding movement of the second base plate 32 in the X-axis direction. In FIG. 4A, the X-axis actuator 34 is attached to an upper portion on the rear face of the first base plate 31, namely, on the side opposite to the imaging plane of the image sensor 30.

The second base plate 32 is a movable base plate interconnected to the first base plate 31 by way of a frictional engaging portion F1 of the X-axis actuator 34, and is comprised of a frame-like member formed by eliminating a central portion of the rectangular shape except for a peripheral portion in the similar manner as the first base plate 31 is formed. The second base plate 32 includes a first slider holding portion 321 having an extension for mounting a slider 343 or the frictional engaging portion F1 of the X-axis actuator 34, which will be described later, and a second slider holding portion 322 for mounting a slider 353 or a frictional engaging portion F2 of the Y-axis actuator 35. The Y-axis actuator 35 is arranged on the front face of the second base plate 32 in positional alignment with the second slider holding portion 322.

The third base plate 33 is a movable base plate interconnected to the second base plate 32 by way of the frictional engaging portion F2 of the Y-axis actuator 35, and is a planar member for holding the image sensor 30 thereon. In an actual arrangement, the third base plate 33 includes a base plate for mounting the image sensor 30, and a heat releaser for releasing heat of the image sensor 30. The third base plate 33 also includes a pair of supports 331, 332 for supporting the Y-axis actuator 35, and a guided portion 333 which is guided in association with the movement of the third base plate 33 by an unillustrated guide portion formed on the second base plate 32. The image sensor 30 is fixed to the front face of the third base plate 33.

The X-axis actuator 34 includes a piezoelectric device 341 constituted of an electromechanical conversion device such as a piezo element, a drive shaft 342 secured to an electrically distorted end or an expanded end of the piezoelectric device 341 in the X-axis direction, the slider 343 which is sidably movable along the drive shaft 342 by frictional engagement therewith, and a weight member 344 secured to the other end of the piezoelectric device 341. The drive shaft 342 is moved in forward and backward directions indicated by the arrows C in FIG. 4A by expansion and contraction of the piezoelectric device 341. The weight member 344 is fixed to the first base plate 31 to restrict further expansion of the piezoelectric device 341. The drive shaft 342 is supported by a pair of supports 3121, 3122 which are attached to the rear face of the first base plate 31, with through-holes formed therein to pass the drive shaft 342. The X-axis actuator 34 is mounted on the X-axis actuator fixing portion 312 of the first base plate 31 in the above-mentioned manner to generate a linear driving force in the X-axis direction.

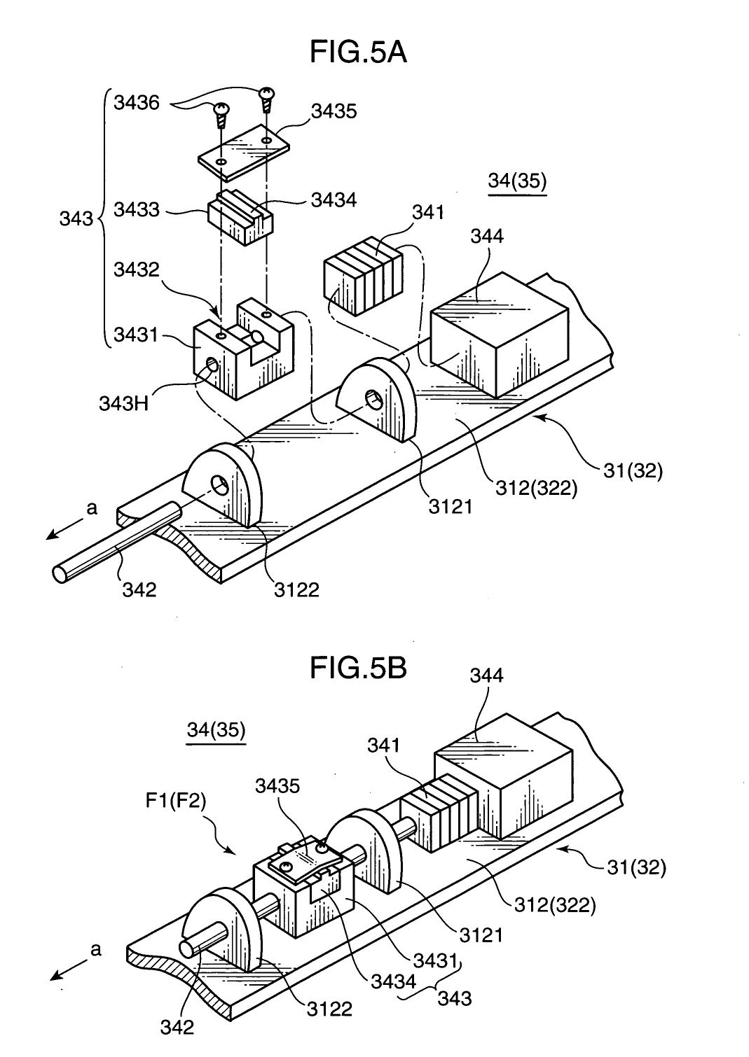

The slider 343 is held on the first slider holding portion 321 of the second base plate 32. As will be described in detail referring to FIG. 5, a relative moving force is given to the slider 343 when the drive shaft 342 is moved in a predetermined direction at a predetermined speed. As a result, the second base plate 32 is moved forward and backward relative to the first base plate 31 in the directions of the arrows C in FIG. 4A when the relative moving force is generated. In other words, the X-axis actuator 34 causes the second base plate 32 to move forward and backward in the directions of the arrows C to thereby shift the image sensor 30 in the X-axis directions.

The Y-axis actuator 35 has substantially the same arrangement as the X-axis actuator 34, and includes a piezoelectric device 351, a drive shaft 352, the slider 353, and a weight member 354. The drive shaft 352 is moved in forward and backward directions shown by the arrows D in FIG. 4A by expansion and contraction of the piezoelectric device 351 in the Y-axis directions. Although not illustrated, the weight member 354 is fixed to a base plate member integrally formed with the third base plate 33. The drive shaft 352 is supported by the support pair 331, 332 attached to the third base plate 33. In this way, the Y-axis actuator 35 is mounted on the third base plate 33 to generate a linear driving force in the Y-axis directions orthogonal to the linear driving force generated by the X-axis actuator 34.

The slider 353 is held on the second slider holding portion 322 of the second base plate 32. A relative moving force is given to the slider 353 when the drive shaft 352 is moved in a predetermined direction at a predetermined speed. As a result, the third base plate 33 is moved relative to the second base plate 32 forward and backward in the directions of the arrows D in the Y-axis directions when the relative moving force is generated. In other words, the Y-axis actuator 35 causes the third base plate 33 to move forward and backward in the directions of the arrows D to thereby shift the image sensor 30 in the Y-axis directions.

FIGS. 5A and 5B are illustrations showing an arrangement of the X-axis actuator 34 (Y-axis actuator 35). FIG. 5A is an exploded perspective view of the X-axis actuator 34 (Y-axis actuator 35), and FIG. 5B is a perspective view of the X-axis actuator 34 (Y-axis actuator 35) in an assembled state. The piezoelectric device 341 is constituted of plural piezoelectric elements placed one over the other in a certain direction by an adhesive. When an electric voltage is applied to the piezoelectric device 341, the piezoelectric device 341 is expanded or contracted depending on the applied voltage. The drive shaft 342 is attached to the one end of the piezoelectric device 341, and the weight member 344 secured to the first base plate 31 is fixed to the other end of the piezoelectric device 341 by an adhesive.

The drive shaft 342 is supported by the supports 3121 and 3122 on the first base plate 31 to be movable in the arrayed direction of the piezoelectric elements constituting the piezoelectric device 341. When a force is acted upon the piezoelectric device 341 fixed to the end of the drive shaft 342 by the adhesive in such a direction as to expand or contract the piezoelectric device 341 in the thickness direction of the piezoelectric device 341, the drive shaft 342 is moved in the axial direction thereof, namely, in the direction of the arrows a in FIGS. 5A and 5B.

The slider 343 (353) constitutes the frictional engaging portion F1 (F2), and includes a slider main body 3431 which is formed with a through-hole 343H for receiving the drive shaft 342, and is frictionally engaged with the drive shaft 342 at a lower part of the frictional engaging portion F1 (F2), a pad member 3433 which is fitted in a cutaway 3432 formed in an upper part of the slider main body 3431, and is frictionally engaged with the drive shaft 342 at an upper part of the frictional engaging portion F1 (F2), and a plate spring 3435 for regulating a frictional engaging force of the drive shaft 342 with the slider main body 3431 and with the pad member 3433. A projecting rib 3434 formed on the pad member 343 is contacted against the plate spring 3435. The frictional engaging force of the drive shaft 342 with the slider main body 3431 and with the pad member 343 can be controlled by regulating fastening forces of screws 3436, 3436 which fasten the plate spring 3435 to the slider main body 3431. In FIGS. 5A and 5B, the second base plate 32 for mounting the slider 343 is not illustrated for sake of simplifying the illustration.

The weight member 344 is adapted to restrict the piezoelectric device 341 from expanding in the direction of the arrow a in FIGS. 5A and 5B, and is fixed to the X-axis actuator fixing portion 312 of the first base plate 31 by an elastic adhesive or the like. Since the arrangement of the Y-axis actuator 35 is substantially the same as that of the X-axis actuator 34, description thereof is omitted herein.

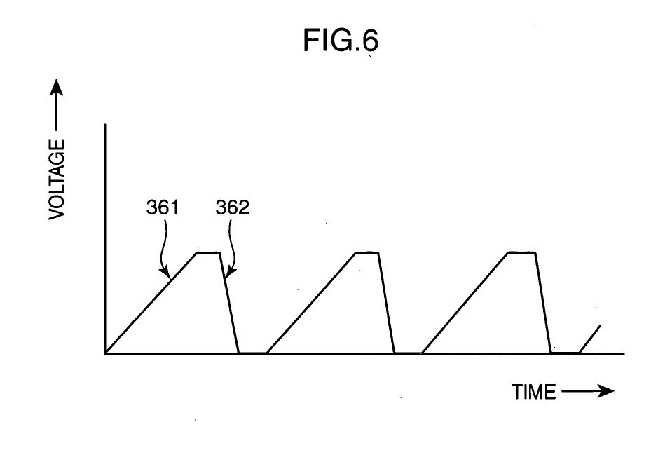

A drive pulse having a waveform comprised of a moderate rising part 361 followed by a sharp falling part 362 is applied to the piezoelectric device 341 of the X-axis actuator 34 (Y-axis actuator 35), as shown in FIG. 6. When the moderate rising part 361 of the drive pulse is applied to the piezoelectric device 341, the piezoelectric device 341 is slowly expanded in the thickness direction thereof, with the result that the drive shaft 342 is displaced in the direction of the arrow a (see FIGS. 5A and 5B). As a result, the second base plate 32 in frictional engagement with the drive shaft 342 via the frictional engaging portion F1 is moved in the direction of the arrow a. In this case, the direction a corresponds to the direction C, namely, the X-axis direction shown in FIG. 4A. In the case where the moderate rising part 361 of the drive pulse is applied to the piezoelectric device 351 of the Y-axis actuator 35, the third base plate 33 in frictional engagement with the drive shaft 352 via the frictional engaging portion F2 is moved in the direction of the arrow D, namely, in the Y-axis direction shown in FIG. 4A.

On the other hand, when the sharp falling part 362 of the drive pulse is applied to the piezoelectric device 341, the piezoelectric device 341 is rapidly contracted in the thickness direction thereof, with the result that the drive shaft 342 is displaced in the direction opposite to the arrow a. At this time, the second base plate 32 which is in the frictional engagement with the drive shaft 342 of the X-axis actuator 34 by way of the frictional engaging portion F1, or the third base plate 33 which is in the frictional engagement with the drive shaft 352 of the Y-axis actuator 35 by way of the frictional engaging portion F2, stays substantially in its position due to the inertial force against the frictional engaging force of the drive shaft 342 (352) with the frictional engaging portion F1 (F2), and is kept unmoved. The phrase “stay substantially” in this context embraces a case that the second base plate 32 and the third base plate 33 are moved in the direction of the arrow a as a whole due to a time lag in driving the second base plate 32 and the third base plate 33, as a result of sliding contact of the drive shaft 342 (352) with the frictional engaging portion F1 (F2), and accompanied movement resulting from the sliding contact in the direction of the arrow a, and in the direction opposite to the arrow a. The moving directions of the second base plate 32 and the third base plate 33 are determined depending on the frictional condition to be applied.

In this way, by sequentially applying the drive pulse having the waveform as shown in FIG. 6 to the piezoelectric device 341 (351), the image sensor 30 is movable in the plus direction of the X-axis and in the plus direction of the Y-axis sequentially by way of the movable second base plate 32 and the movable third base plate 33. Likewise, the image sensor 30 is movable in the minus direction of the X-axis and in the minus direction of the Y-axis, namely, in the direction opposite to the arrow a sequentially by inverting polarities of electrodes of the piezoelectric device 341 (351) and by applying a drive pulse having the waveform as shown in FIG. 6.

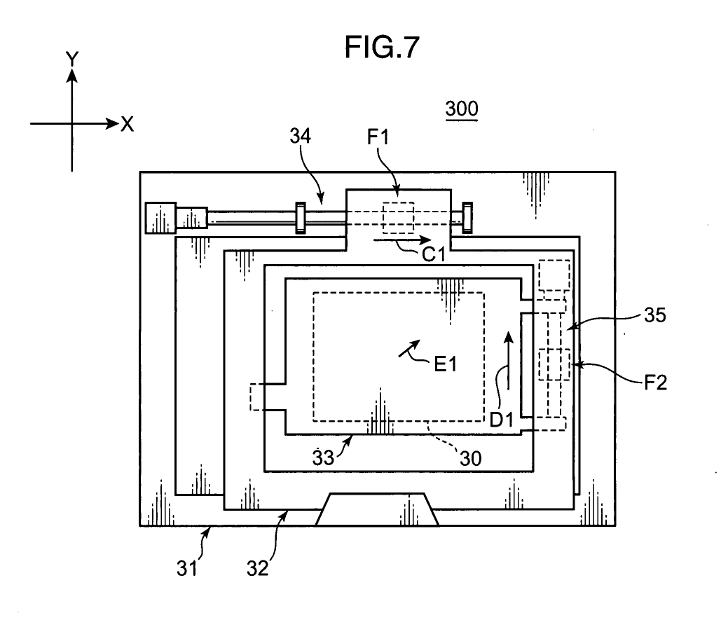

FIG. 7 is a rear view of the driving mechanism 300 showing a state that the image sensor 30 is moved to its limit in the plus direction of the X-axis, namely, in the direction of the arrow C1 in FIG. 7 and in the plus direction of the Y-axis, namely, in the direction of the arrow D1 in FIG. 7 by the X-axis actuator 34 and the Y-axis actuator 35, respectively. Specifically, if the state of FIG. 4A represents an initial centering position corresponding to the first position of the image sensor 30, in which the center of the image circle of the photographing optical system, and the center O of the imaging plane of the image sensor 30 coincide with each other, for instance, FIG. 7 shows a state that the image sensor 30 is shifted to an upper right corner position corresponding to the second position in the direction of the arrow E1 by driving of the X-axis actuator 34 and the Y-axis actuator 35. Two different images, namely, a first image and a second image having different photographing areas from each other are obtained by causing the image sensor 30 to perform image capturing operations at the first position and at the second position, respectively. Also, it is possible to obtain a composite image expanded in four side directions of the image sensor 30 with the first image being used as a central image, for instance, by sequentially moving the image sensor 30 to the upper right corner position, the lower right corner position, the lower left corner position, and to the upper left corner position and by causing the image sensor 30 to perform image capturing operations at the respective positions by driving the X-axis actuator 34 and the Y-axis actuator 35.

Returning to FIG. 3, the AF driving unit 41 includes an AF actuator 411, an output shaft 412, and an encoder 413. The AF actuator 411 is adapted to generate a driving force for AF control, and includes a motor such as a DC motor, a stepping motor, and an ultrasonic motor, as well as an illustrated speed reducer for reducing the rotating number of the motor. The output shaft 412 is adapted to transmit the driving force from the AF actuator 411 to a lens driving mechanism 24 in the lens unit 2. The encoder 413 is adapted to detect the driving amount, namely, the rotation amount transmitted to the output shaft 412 of the AF actuator 411. The detected rotation amount is used for calculating the position of the lens group 21 in the lens unit 2. The output shaft 412 and the lens driving mechanism 24 are connected to each other via the coupler 414, which is adapted for mechanical connection of the output shaft 412 and the lens driving mechanism 24.

The phase difference AF module 42 is arranged underneath the mirror box 44, and is adapted to detect the focal position by a well-known phase difference detection system. The digital camera 1 has a function, namely, a main subject specifying section for specifying the main subject image on the image sensor 30 by using a signal outputted from the phase difference AF module 42.

The shutter unit 43 has a focal plane shutter, and is arranged between the rear face of the mirror box 44 and the image senor 30.

The mirror box 44 has a quick return mirror 441 and a sub mirror 442. The position of the quick return mirror 441 is pivotally changeable about a pivot pin 443 between a position as shown by the solid line in FIG. 3 (hereinafter, called as a “tilt position of the quick return mirror 441”) where the quick return mirror 441 is titled by about 45 degrees with respect to the optical axis L of the lens group 21 constituting the photographing optical system, and a position as shown by the imaginary line in FIG. 3 (hereinafter, called as a “horizontal position of the quick return mirror 441”) where the quick return mirror 441 is aligned substantially parallel to the bottom face of the camera body 10.

The sub mirror 442 is arranged behind the quick return mirror 441, namely, on the side of the image sensor 30. The position of the sub mirror 442 is changeable in association with the movement of the quick return mirror 441 between a position as shown by the solid line in FIG. 3 (hereinafter, called as a “tilt position of the sub mirror 442”) where the sub mirror 442 is titled by about 90 degrees with respect to the quick return mirror 441 at the tilt position, and a position as shown by the imaginary line in FIG. 3 (hereinafter, called as a “horizontal position of the sub mirror 442”) where the sub mirror 442 is aligned substantially parallel to the quick return mirror 441 at the horizontal position. The quick return mirror 441 and the sub mirror 442 are driven by a mirror driving actuator 44M (see FIG. 8), which will be described later.

While the quick return mirror 441 and the sub mirror 442 are set at their respective tilt positions, the quick return mirror 441 reflects a large part of rays of the subject image guided in the direction of the optical axis L onto the optical viewfinder 18, namely, onto a focusing glass 45 while allowing the remaining part of the rays to pass, and the sub mirror 442 guides the rays of the subject image that have passed through the quick return mirror 441 to the phase difference AF module 42. At this time, the subject image is displayed on the optical viewfinder 18, and focus control according to the phase difference detection system is executed by the phase difference AF module 42. However, since the rays of the subject image are not introduced to the image sensor 30 in this state, the subject image is not displayed on the LCD 14.

On the other hand, when the quick return mirror 441 and the sub mirror 442 are set to their respective horizontal positions, the quick return mirror 441 and the sub mirror 442 are retracted from the optical axis L. Accordingly, substantially all the rays of the subject image that have been guided in the direction of the optical axis L are introduced to the image sensor 30. At this time, although the subject image is displayed on the LCD 14, the subject image is not displayed on the optical viewfinder 18, and focus control according to the phase difference detection system by the phase difference AF module 42 is not implemented.

The optical viewfinder 18 is arranged above the mirror box 44 which is disposed substantially in the middle of the camera body 10. The optical viewfinder 18 has the focusing glass 45, a prism 46, an eyepiece element 47, and a viewfinder display device 48. The prism 46 laterally reverses a subject image formed on the focusing glass 45, and guides the laterally-reversed subject image to the eye of the photographer via the eyepiece element 47, so that the photographer can visually recognize the subject image. The viewfinder display device 48 is adapted to display various parameters such as a shutter speed, an aperture value, and an exposure correction value on a lower part of a display screen defined by a viewfinder frame.

In FIG. 3, the anti-shake sensor 49 constituted of the X-sensor 49a and the Y-sensor 49b is illustrated as a single member.

The main controller 62 includes a microcomputer incorporated with a storage such as an ROM for storing a control program, and a flash memory for temporarily storing data. The function of the main controller 62 will be described later in detail.

Now, the lens unit 2 to be attached to the camera body 10 is described. As shown in FIG. 3, the lens unit 2 has the lens group 21 constituting the photographing optical system, the lens barrel 22, the lens driving mechanism 24, a lens position detector 25, and a lens controller 26.

The lens group 21 is constructed in such a manner that the focus lens element 211, the zoom lens element 212, and a diaphragm 23 for controlling the amount of light to be incident onto the image sensor 30 in the camera body 10 are held in the lens barrel 22 in the direction of the optical axis L to guide and form a subject optical image onto the image sensor 30 or a like device. Change of the zoom ratio or the focal length, and focus control are performed by driving the lens group 21 in the direction of the optical axis L by the AF actuator 411 in the camera body 10.

The lens driving mechanism 24 includes a helicoid and an unillustrated gear for rotating the helicoid, for instance. The lens driving mechanism 24 is adapted to move the lens group 21 as a unit in the direction of the arrow A parallel to the optical axis L upon receiving a driving force from the AF actuator 411 by way of the coupler 414. The moving direction and the moving distance of the lens group 21 are determined based on the rotation direction and the rotation number of the AF actuator 411, respectively.

The lens position detector 25 includes an encoder plate in which plural code patterns are formed at a certain pitch in the direction of the optical axis L within a movable range of the lens group 21, and an encoder brush which is integrally moved with the lens barrel 22 in sliding contact with the encoder plate. The lens position detector 25 is adapted to detect the moving distance of the lens group 21 at the time of focus control.

The lens controller 26 is constituted of a microcomputer incorporated with a storage such as an ROM for storing a control program, and a flash memory for temporarily storing data. The lens controller 26 includes a communications section for communicating with the main controller 62 in the camera body 10. Specifically, the communications section in the lens controller 26 sends, to the main controller 62, data regarding a focal length of the zoom lens element 212, and receives, from the main controller 62, data regarding a driving amount of the focus lens element 211, for instance. The storage stores therein data regarding the focal length of the zoom lens element 212, and the image circle of the lens unit 2, and data regarding the driving amount of the focus lens element 211 sent from the main controller 62, for instance.

In the case where the image circle is exceedingly small as in a lens unit for an advanced photo system (APS), it is difficult to perform shift photographing, because a defect image may be generated by moving the image sensor 30 for shift photographing. In view of this, in this embodiment, the shift photographing is prohibited if the main controller 62 detects communications information from the lens controller 26 that a lens unit incapable of performing shift photographing has been mounted.

(Description on Electrical Configuration of Digital Camera)

In this section, an electrical configuration of the digital camera 1 having the above arrangement is described. FIG. 8 is a block diagram showing an electrical configuration of the entirety of the digital camera 1 in a state that the lens unit 2 is attached to the camera body 10. Elements identical to or equivalent to those in FIGS. 1 through 3 are denoted by the same reference numerals. Since the electrical configuration of the lens unit 2 has been described above, an electrical configuration of the camera body 10 is primarily described in this section.

The camera body 10 includes, in addition to the image sensor 30 and the driving mechanism 300 described referring to FIGS. 1 through 3, an analog front end (AFE) 5, an image processor 61, an image memory 615, the main controller 62 corresponding to an imaging controlling section/image synthesizing section, a flash circuit 63, an operating section 64, a VRAM 65, a card interface (I/F) 66, a memory card 67 corresponding to a storage, a communications interface (I/F) 68, a power source circuit 69, the battery 69B, a focus driving controller 41A, a shutter driving controller 43A, a shutter driving actuator 43M, a mirror driving controller 44A, and the mirror driving actuator 44M.

The image sensor 30 includes the CCD color area sensor as mentioned above, and image capturing operations such as start and completion of an exposure operation of the image sensor 30, and readout of pixel signals from the respective pixels of the image sensor 30 including horizontal synchronization, vertical synchronization, and transfer are controlled by a timing controlling circuit 51, which will be described later.

The AFE 5 is adapted to supply a timing pulse to cause the image sensor 30 to perform a predetermined operation, apply a predetermined signal processing to an image signal outputted from the image sensor 30, namely, an analog signal group representing light amounts received on the respective pixels of the image sensor 30, and to convert the analog signals into digital signals for outputting to the image processor 61. The AFE 5 is constituted of the timing controlling circuit 51, a signal processor 52, and an analog-to-digital converter 53.

The timing controlling circuit 51 generates a predetermined timing pulse such as a vertical transfer pulse, a horizontal transfer pulse, and a charge sweep pulse based on a reference clock outputted from the main controller 62, outputs the timing pulse to the image sensor 30 for controlling an image capturing operation of the image sensor 30. Also, the timing controlling circuit 51 controls operations of the signal processor 52 and the A/D converter 53 by outputting the timing pulse to the signal processor 52 and to the A/D converter 58, respectively.

The signal processor 52 is adapted to apply a predetermined analog signal processing to an analog image signal outputted from the image sensor 30. The signal processor 52 includes a correlation double sampling (CDS) circuit, an auto gain control (AGC) circuit, and a clamp circuit corresponding to a clamping section. The CDS circuit reduces a reset noise in an analog image signal voltage. The AGC circuit performs level adjustment of the analog image signal. The clamp circuit clamps a signal voltage obtained based on an output signal voltage from a pixel constituting an optical black element of the image sensor 30, as an electric potential called as an OB potential representing the black level of the image signal.

The A/D converter 53 is adapted to convert analog image signals of R, G, and B outputted from the signal processor 52 into respective digital image signals of plural bits, e.g., 10 bits, based on the timing pulse outputted from the timing controlling circuit 51.

The image processor 61 is adapted to create an image file by performing a predetermined signal processing to the image data outputted from the AFE 5, and is constituted of a black level correction circuit 611, a pixel interpolation circuit 612, a white balance controlling circuit 613, and a gamma correction circuit 614. The image data saved in the image processor 61 is temporarily written into the image memory 615 as timed with a readout operation of the image sensor 30. Thereafter, image processing is performed in each block of the image processor 61 by accessing the image data written in the image memory 615.

The black level correction circuit 611 converts the black level of the digital image signals of R, G, B which have been analog-to-digital converted by the A/D converter 53 into a reference black level.

The pixel interpolation circuit 612 is adapted to interpolate data at a pixel position in a frame image where data does not exist with respect to each color component of R, G, B. The pixel interpolation circuit 612 masks image data constituting a frame image of the color component G having pixels up to a high wavelength band with a predetermined filter pattern, and calculates an average of the pixel data on the periphery of the targeted pixel position to be interpolated excluding a maximal value and a minimal value with use of a median filter, and sets the average as the pixel data of the targeted pixel position for interpolation. Also, the pixel interpolation circuit 612 masks the image data constituting a frame image of each of the color components R and B with a predetermined filter pattern, calculates an average of the pixel data on the periphery of the targeted pixel position to be interpolated, and sets the average as the pixel data of the targeted pixel position for interpolation.

The white balance controlling circuit 613 is adapted to perform level conversion or white balance (WB) adjustment of the digital signals of the color components of R, G, and B based on a white reference value which varies depending on a light source. Specifically, the white balance controlling circuit 613 specifies a portion of a captured subject image, which is supposed to be of a white color in the aspect of luminance data, saturation data, and the like, based on WB data outputted from the main controller 62, obtains respective averages of the color components R, G, and B in the white portion, G/R ratio, and G/B ratio, and performs level conversion to obtain correction gains of the color components R and B.

The gamma correction circuit 614 is adapted to correct gradation characteristics of the image data after the WB adjustment. Specifically, the gamma correction circuit 614 non-linearly converts the level of image data by using a gamma correction table defined in association with each of the color components R, G, and B, and performs offset adjustment.

The image memory 615 is a memory which is adapted to temporarily store the image data outputted from the image processor 61 while the digital camera 1 is in the photographing mode, and is used as a work area for applying a predetermined processing to the image data by the main controller 62. Also, the image memory 615 temporarily stores therein image data read out from the memory card 67.

The main controller 62 controls operations of the respective parts in the digital camera 1 shown in FIG. 8. In this embodiment, the main controller 62 functionally includes an AF controller 621, an anti-shake controller 622, and an area enlarge controller 623.

The AF controller 621 is adapted to perform focus control according to a phase difference detection system by using an output signal from the phase difference AF module 42, generates a focus control signal, namely, an AF control signal, and operates the AF actuator 411 via the focus driving controller 41A for driving of the focus lens element 211.

The anti-shake controller 622 is adapted to calculate a shake direction and a shake amount of the digital camera 1 based on a shake detection signal from the anti-shake sensor 49, generates a shake correction control signal based on the shake direction and the shake amount for outputting to the driving mechanism 300, and drivingly shifts the image sensor 30 in such a direction as to cancel the shake when the anti-shake mode is executed.

The area enlarge controller 623 outputs a predetermined control signal to the driving mechanism 300 to sequentially move the image sensor 30 to predetermined different positions and to cause the image sensor 30 to perform image capturing operations at the respective positions for shift photographing, and stores the plural images obtained by the shift photographing operations in the memory card 67 in correlation to each other so that a composite image is creatable by joining the images. The area enlarge controller 623 will be described later in detail.

The flash circuit 63 is adapted to control the light emission amount of a flash device connected to the connecting terminal portion 106 to a predetermined amount defined by the main controller 62 in the flash photographing mode.

The operating section 64 includes the mode setting dial 11, the control value setting dial 12, the shutter button 13, the setting button group 15 such as the anti-shake switch 15a and the shift photographing switch 15b, the jog dial 16, the push button 17, and the main switch 105, and allows the user to input information relating to an operation of the digital camera 1 to the main controller 62.

The VRAM 65 is a buffer memory for linking the main controller 62 to the LCD 14, with a capacity of recording image signals corresponding to the number of pixels of the LCD 14. The card I/F 66 is an interface for allowing a signal to be communicated between the memory card 67 and the main controller 62.

The memory card 67 is adapted to save image data generated in the main controller 62. Plural images which have been photographed in the shift photographing mode before execution of image synthesis are also temporarily stored in the memory card 67 to be readout therefrom in an image synthesizing operation. The images before the image synthesizing operation may be stored in the image memory 615.

The communications I/F 68 is an interface for enabling transmission of image data or the like to a personal computer or other external device. In the case where an image synthesizing operation is performed by a personal computer or an equivalent device, the images photographed in the shift photographing mode are outputted to the external device via the communications I/F 68.

The power source circuit 69 includes a constant voltage circuit, for instance. The constant voltage circuit is adapted to generate a voltage e.g. 5V to drive the entirety of the digital camera 1 such as the controlling sections including the main controller 62, the image sensor 30, and other various driving sections. The battery 69B includes a primary cell such as an alkaline dry cell, and a secondary cell such as a nickel metal-hydride rechargeable battery, and is a power source for supplying a power to the entirety of the digital camera 1.

The focus driving controller 41A is adapted to generate a drive control signal, which is required to move the focus lens element 211 to a focal position and to move the zoom lens element 212 to a predetermined position, based on the AF control signal from the AF controller 621 of the main controller 62 to control the AF actuator 411.

The shutter driving actuator 43M is an actuator for drivingly opening and closing the shutter unit 43. The shutter driving controller 43A generates a drive control signal based on a control signal from the main controller 62 to control the shutter driving actuator 43M.

The mirror driving actuator 44M is an actuator for pivoting the quick return mirror 441 in the mirror box 44 between its horizontal position and its tilted position. The mirror driving controller 44A is adapted to generate a drive signal for driving the mirror driving actuator 44M in synchronism with a photographing timing.

(Detailed Description on Area Enlarge Controller)

FIG. 9 is a functional block diagram showing a functional arrangement of the area enlarge controller 623. The area enlarge controller 623 is adapted to control a shift photographing operation and an operation of generating a composite image by joining plural images obtained by the shift photographing operations. The area enlarge controller 623 is operative to read out a control program from an unillustrated ROM or the like in the case where the shift photographing mode is selected in response to turning on of the shift photographing switch 15b, and functions as a shift photographing controller 71 corresponding to the imaging controlling section, an image synthesis controller 72 corresponding to an image synthesizing section, a drive pattern storage 73, and a moving amount storage 74.

The shift photographing controller 71 controls shift photographing operations of the image sensor 30 in such a manner that at least a first image and a second image are obtained, wherein the first image is obtained by causing the image sensor 30 to perform an image capturing operation with the image sensor 30 being located at the first position, and the second image is obtained by causing the image sensor 30 to perform an image capturing operation with the image sensor 30 being located at the second position different from the first position by driving of the driving mechanism 30.

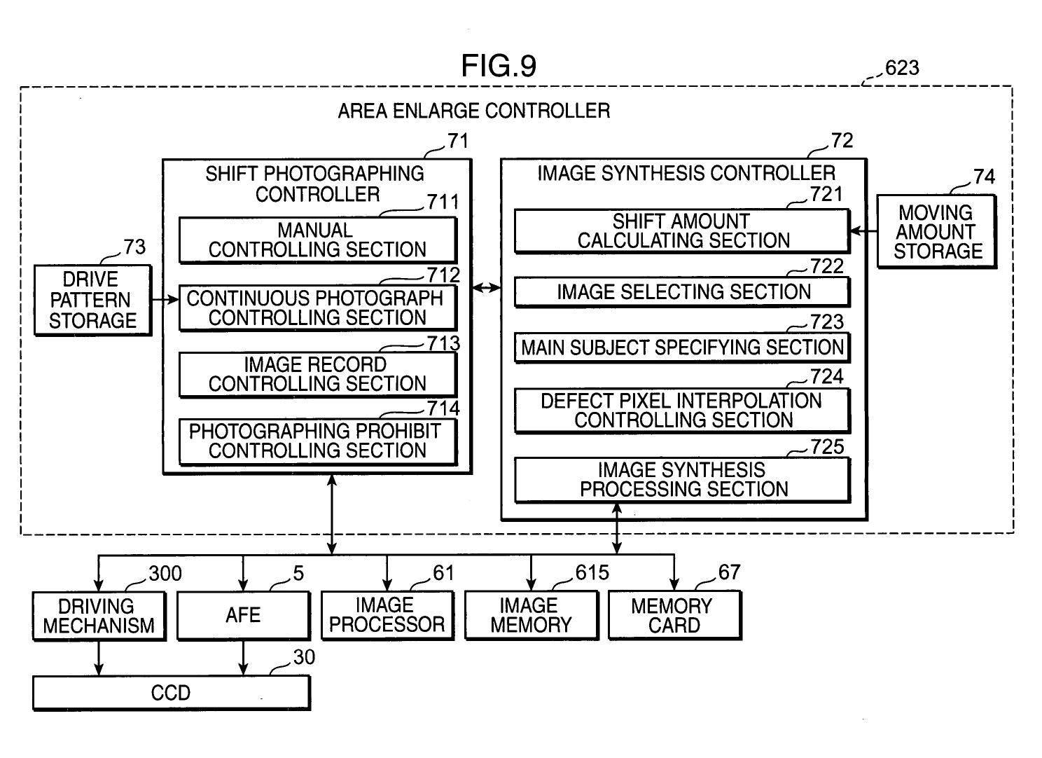

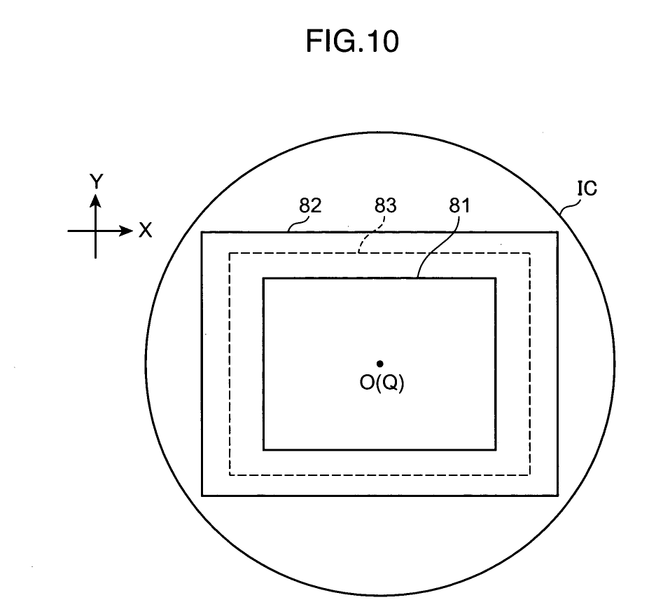

FIG. 10 is an illustration showing a relation between an image circle IC of the photographing optical system, namely, of the lens group 21 in the lens unit 2, and an imaging area 81 of the image sensor 30. The imaging area 81 has a rectangular shape in conformity to the size of the image sensor 30. The rectangular area in the periphery of the imaging area 81 which is denoted by the reference numeral 82 is a sensor moving limit area representing a maximal movable area of the image sensor 30. The sensor moving limit area 82 is an area corresponding to a boundary within which the second base plate 32 and the third base plate 33 (see FIG. 4), which are the movable base plates, are allowed to move maximally. The rectangular area denoted by the reference numeral 83 is an anti-shake moving limit area, which represents a maximal movable area of the image sensor 30 when the image sensor 30 is moved for anti-shake control. The anti-shake moving limit area 83 is an area within which the image sensor 30 is controllably and finely moved and stopped by the X-axis actuator 34 and the Y-axis actuator 35.

The image circle IC has such dimensions as to substantially cover the sensor moving limit area 82. With such dimensions of the image circle IC, photographing without appearance of vignetting can be performed in whichever direction the imaging area 81 may be moved within the sensor moving limit area 82. The shift photographing controller 71 controls the image sensor 30 to move to such a position that the imaging area 81 is located at a predetermined position within the sensor moving limit area 82, and causes the image sensor 30 to perform an image capturing operation at the predetermined position. FIG. 10 shows a state that the center O of the imaging area 81 coincides with the center Q of the image circle IC, namely, the center of the optical axis L. The shift photographing controller 71 controls the X-axis actuator 34 and the Y-axis actuator 35 to move the image sensor 30 in the X-axis direction and in the Y-axis direction, respectively, with the state shown in FIG. 10 set as an initial position or the centering position of the image sensor 30 for performing an image capturing operation.

There is a case that the image circle IC may not cover the entirety of the sensor moving limit area 82 depending on the kind of the lens unit 2. In such a case, the moving range of the imaging area 81 is restricted within the image circle IC. A case that the imaging area 81 is completely unmovable will be described later. Information relating to the image circle IC is acquired by communication between the lens controller 26 (see FIG. 3) and the main controller 62 when the lens unit 2 is attached to the camera body 10 or when the focal length or the focal point is determined in an image capturing operation.

Referring back to FIG. 9, the shift photographing controller 71 includes a manual controlling section 711, a continuous photograph controlling section 712, an image record controlling section 713, and a photographing prohibit controlling section 714. The manual controlling section 711 is adapted to move the image sensor 30 in accordance with manipulation of the user in the case where the shift photographing mode is designated in response to pressing of the shift photographing switch 15b, and the mode of manually moving the image sensor 30 is designated.

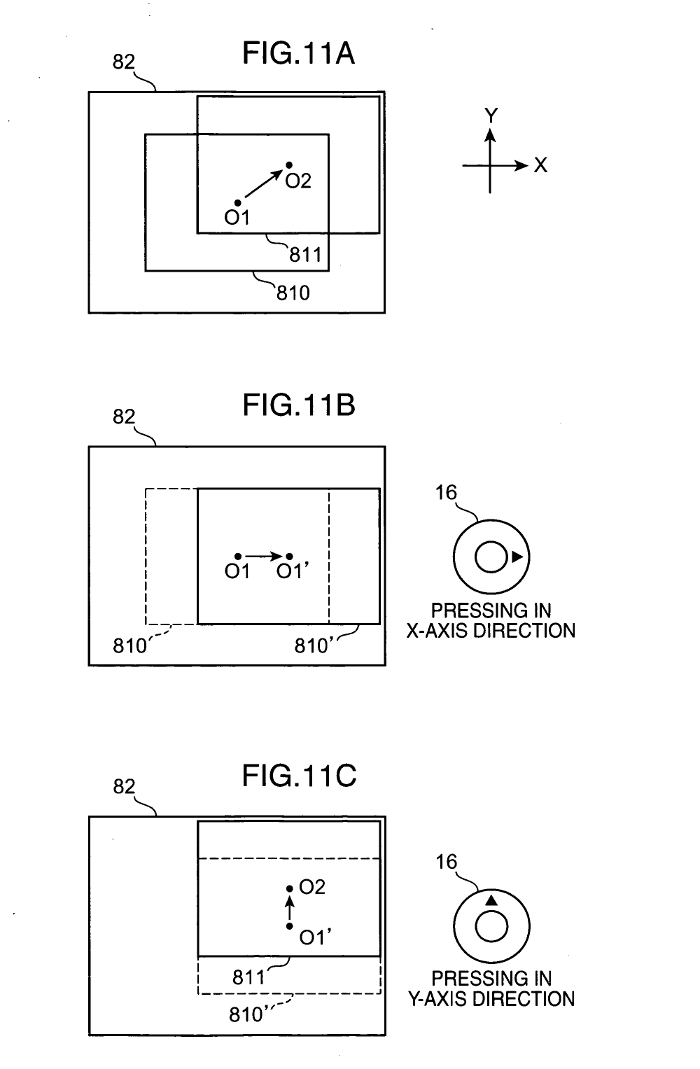

FIGS. 11A through 11C are illustrations showing an example as to how the imaging area 81 is moved when the mode of manually moving the image sensor 30 is designated. FIG. 11A shows a state that the imaging area 81 is moved from the first position 810 to the second position 811. In this case, the center of the imaging area 81 is moved from O1 to O2, and as a result, the image sensor 30 is moved to the upper right corner position of the sensor moving limit area 82. The manual controlling section 711 causes the jog dial 16 to function as an operation key for moving the image senor 30 when the image sensor 30 is moved in the manual mode.

As shown in FIG. 11B, when the relevant pressing portion of the jog dial 16 is pressed to move the image sensor 30 in the plus direction of the X-axis, the image sensor 30 is moved from the first position 810, namely, from the centering position to its limit position in the plus direction of the X-axis. As a result, the imaging area 81 is moved to an intermediate position 810′. In other words, the center of the imaging area 81 is horizontally moved from O1 to O1′. Subsequently, as shown in FIG. 11C, when the relevant pressing portion of the jog dial 16 is pressed to move the image sensor 30 in the plus direction of the Y-axis, the image sensor 30 is moved to such a position that the imaging area 81 is moved from the intermediate position 810′ to its limit position in the plus direction of the Y-axis. As a result, the imaging area 81 is moved to the second position 811. In other words, the center of the imaging area 81 is vertically moved from O1′ to O2. An image capturing operation is performed when the user presses the shutter button 13, with the image sensor 30 located at the first position 810 and at the second position 811, respectively. In FIGS. 11A through 11C, the direction of pressing the jog dial 16 and the actual moving direction of the image sensor 30 are made coincident with each other. Alternatively, it is possible to move the image sensor 30 leftward in FIG. 11B, for instance, so that the direction of pressing the jog dial 16 and the moving direction of the imaging area 81 recognized in a live-view image are made coincident with each other in a digital camera which is designed that the live-view image is displayable during movement of the image sensor 30.

In the case where the shift photographing mode is designated, and the mode of automatically and sequentially moving the image senor 30 is designated, the continuous photograph controlling section 712 controls the image sensor 30 to sequentially perform image capturing operations by sequentially moving the image sensor 30 to predetermined positions in a predetermined order by the driving mechanism 300 and by causing the image sensor 30 to perform image capturing operations at the respective positions sequentially in response to a pressing operation of the shutter button 13, namely, an input of a predetermined operation signal. Specifically, the continuous photograph controlling section 712 drives the X-axis actuator 34 and the Y-axis actuator 35 based on a drive pattern stored in the drive pattern storage 73 to sequentially move the image sensor 30 to the predetermined positions in the predetermined order, and to cause the image sensor 30 to sequentially perform image capturing operations at the respective positions.

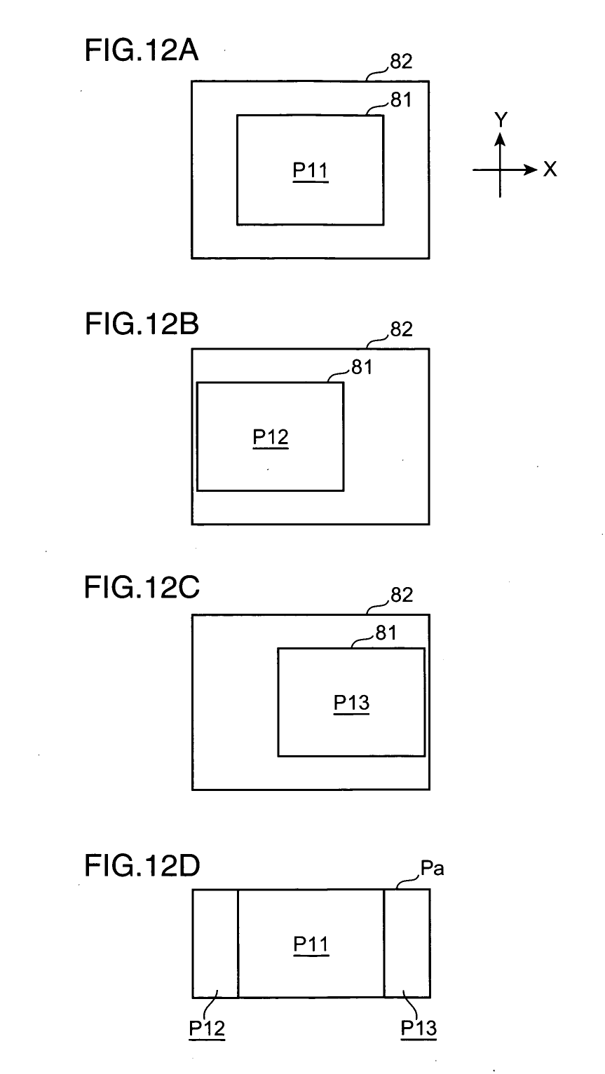

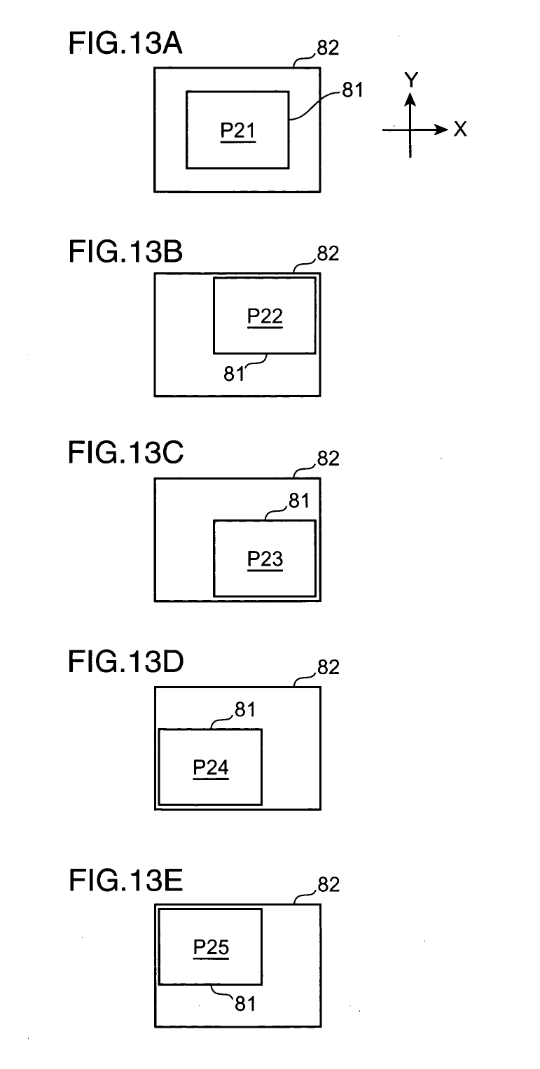

FIGS. 12A through 13E are illustrations showing examples as to how the imaging area 81 is moved by the continuous photograph controlling section 712. In this embodiment, the image sensor 30 is a rectangular image sensor, and is movable in the X-axis direction parallel to the horizontal side of the image sensor 30 on a plane orthogonal to the optical axis, and in the Y-axis direction parallel to the vertical side of the image sensor 30. FIGS. 12A through 12D are illustrations showing a moving pattern of the imaging area 81 to create a panoramic composite image with its horizontal side in the X-axis direction longer than its vertical side. In creating the panoramic composite image, first, as shown in FIG. 12A, a first image P11 is obtained by causing the image sensor 30 to perform an image capturing operation at a position corresponding to the centering position or a first position of the imaging area 81.

Next, as shown in FIG. 12B, a second image P12 is obtained by moving the imaging area 81 in the minus direction of the X-axis to move the image sensor 30 to its limit position in the minus direction of the X-axis, namely, to a second position on the sensor moving limit area 82, and by causing the image sensor 30 to perform an image capturing operation at the second position. Then, as shown in FIG. 12C, a third image P13 is obtained by moving the imaging area 81 in the plus direction of the X-axis to move the image sensor 30 to its limit position in the plus direction of the X-axis, namely, to a third position on the sensor moving limit area 82 in the similar manner as obtaining the second image P12. In this way, the first image P11, the second image P12, and the third image P13 are obtained so that a panoramic composite image Pa with its horizontal side longer than its vertical side as shown in FIG. 12D is creatable by image synthesis. In other words, this arrangement enables to generate a composite image having an aspect ratio different from the aspect ratio of the image sensor 30, and enables to generate a composite image having an intended aspect ratio without depending on the aspect ratio of the image sensor 30. It is possible to adopt a moving pattern according to which the second image P12 is obtained first, followed by the first image P11 and the third image P13 successively to speed up the continuous photographing.

FIGS. 13A through 13E are illustrations showing a moving pattern of the imaging area 81 to create a composite image of a full size corresponding to the entirety of the sensor moving limit area 82. As shown in FIG. 13A, a first image P21 is obtained by causing the image sensor 30 to perform an image capturing operation at a first position corresponding to the centering position of the imaging area 81. Next, as shown in FIG. 13B, a second image P22 is obtained by moving the imaging area 81 in the plus direction of the X-axis and in the plus direction of the Y axis to move the image sensor 30 to its limit position, namely, to a second position corresponding to an upper right corner position, and by causing the image sensor 30 to perform an image capturing operation at the second position.

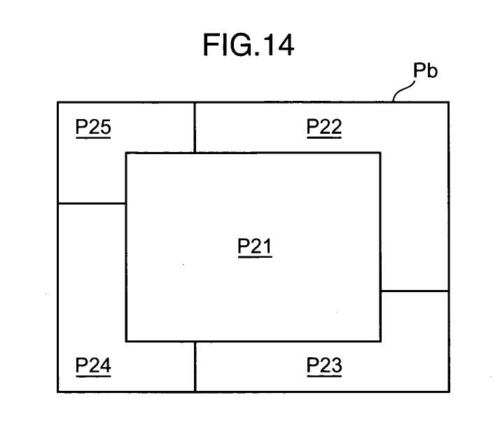

Then, as shown in FIGS. 13C through 13E, in the similar manner as obtaining the first image P21 and the second image P22, a third image P23 is obtained at a lower right corner position, namely, at a third position, a fourth image P24 is obtained at a lower left corner position, namely, at a fourth position, and a fifth image P25 is obtained at an upper left corner position, namely, at a fifth position by sequentially moving the imaging area 81 to the respective corresponding limit positions on the sensor moving limit area 82. Thereby, the first image P21, the second image P22, the third image P23, the fourth image P24, and the fifth image P25 are obtained so that a composite image Pb of a fill size is creatable by image synthesis, as shown in FIG. 14. The moving pattern of the imaging area 81 is not limited to the order as shown in FIGS. 13A through 13E, but may be arbitrarily set.

The image record controlling section 713 stores the images obtained by the shift photographing operations in the memory card 67 in correlation to each other so that a composite image is creatable by joining the images. The images obtained by the shift photographing operations are the first image P11, the second image P12, and the third image P13 in the example of FIGS. 12A through 12D, and the first image P21, the second image P22, the third image P23, the fourth image P24, and the fifth image P25 in the example of FIGS. 13A through 13E.

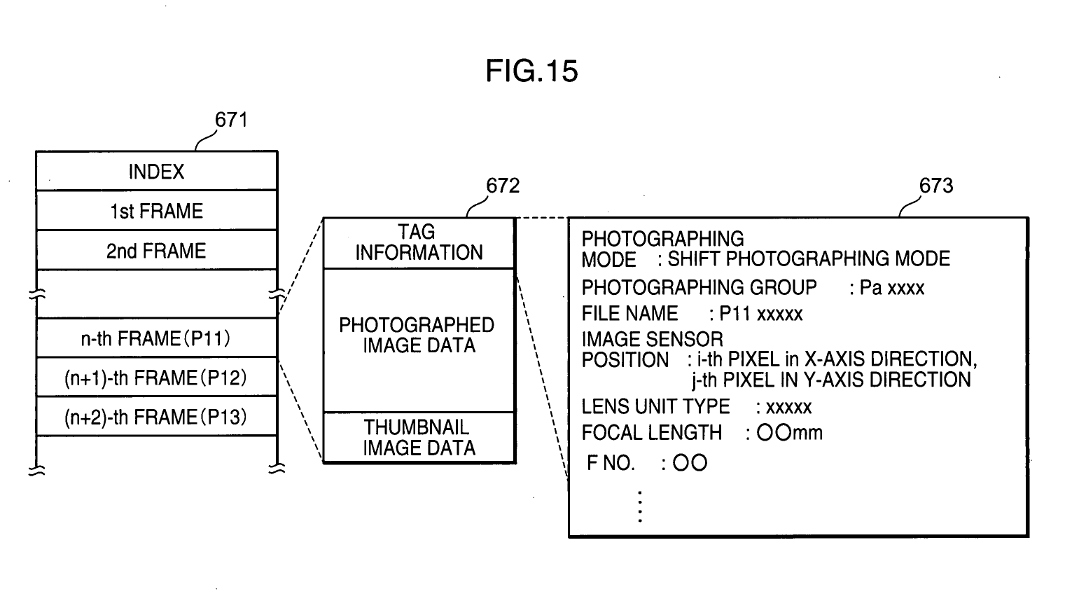

FIG. 15 is an illustration showing a manner as to how the images obtained by the shift photographing operations are recorded in the memory card 67 by the image record controlling section 713, as image files. An index area 671 for storing information relating to folders, and information relating to an image file belonging to each of the folders is provided in a leading storage section of the memory card 67, and each of the image files 672 is stored in an area following the index area 671 in the order of the file number. The storage area of each image file 672 is divided into three sections, wherein the upper section 673 stores therein tag information, the middle section stores therein photographed image data, and the lower section stores therein thumbnail image data.

The image record controlling section 713 records, in the tag information section 673, information for correlating the images obtained by the shift photographing operations to each other according to the recording system as illustrated in FIG. 15. FIG. 15 shows a case that the first image P11 as exemplified in FIG. 12A, the second image P12 as exemplified in FIG. 12B, and the third image P13 as exemplified in FIG. 12C are recorded as the n-th frame of image, (n+1)-th frame of image, and the (n+2)-th frame of image in the index area 671, respectively. In this case, the image recording controlling section 713 writes, in the tag information section 673, various information relating to the images. In the case of the first image P11, the image recording controlling section 713 writes in the tag information section 673 that the first image P11 is an image obtained when the digital camera 1 is in the shift photographing mode, and that the photographing group of the first image P11 in the shift photographing belongs to the panoramic composite image Pa, as well as the file name inherent to the photographing group, and the position of the image sensor 30 at the time of capturing the first image P11 relative to its home position, which is expressed in terms of a number of pixels arrayed in the X-axis direction or in the Y-axis direction (hereinafter, called as “pixel array number of the image senor 30”), which will be described later in detail. Similarly, information relating to the second image P12 and the third image P13 is written in the tag information section 673. In this way, the first image P11, the second image P12, and the third image P13 are stored in the memory card 67 in correlation to each other so that the panoramic composite image Pa is easily created by reading out the first image P11, the second image P12, and the third image P13 from the memory card 67 afterwards.

The photographing prohibit controlling section 714 judges the kind of the lens unit 2 attached to the camera body 10, and prohibits execution of the shift photographing mode in the case where a lens unit of a specific kind is mounted. For instance, upon receiving communications information from the lens controller 26 in the lens unit 2 that a lens unit for APS is mounted on the camera body 10, the photographing prohibit controlling section 714 prohibits movement of the image sensor 30 by the driving mechanism 300 based on the shift photographing mode.

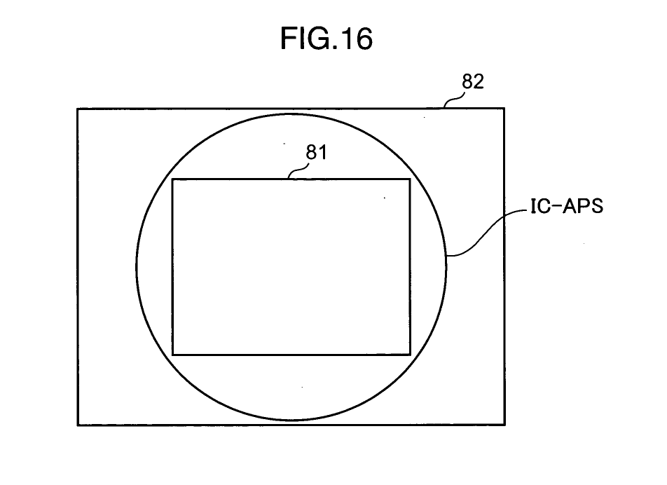

FIG. 16 is an illustration showing a relation between an image circle IC-APS of an APS-lens unit, and the imaging area 81. Generally, the image circle IC-APS is small with such an area just enough to cover the imaging area 81 at the centering position. In this case, vignetting may likely to appear if the imaging area 81 is attempted to move within the sensor moving limit area 82. In view of this, the photographing prohibit controlling section 714 prohibits execution of the shift photographing mode if mounting of the lens unit having a small image circle such as an APS lens unit is detected.

Referring back to FIG. 9, the image synthesis controller 72 creates a composite image by joining the images obtained by the shift photographing operations of the shift photographing controller 71. The image synthesis controller 72 is constituted of a shift amount calculating section 721, an image selecting section 722 corresponding to a selecting section, a main subject specifying section 723, a defect pixel interpolation controlling section 724, and an image synthesis processing section 725.

The shift amount calculating section 721 obtains a shift amount of the imaging area 81 by calculating the moving amount of the image sensor 30 by the driving mechanism 300 in the X-axis direction, namely, in the first axis direction and in the Y-axis direction, namely, in the second axis direction in terms of the pixel array number of the image sensor 30 based on information from the moving amount storage 74, which stores the movable amount of the image sensor 30 in correlation to the pixel array number of the image sensor 30.

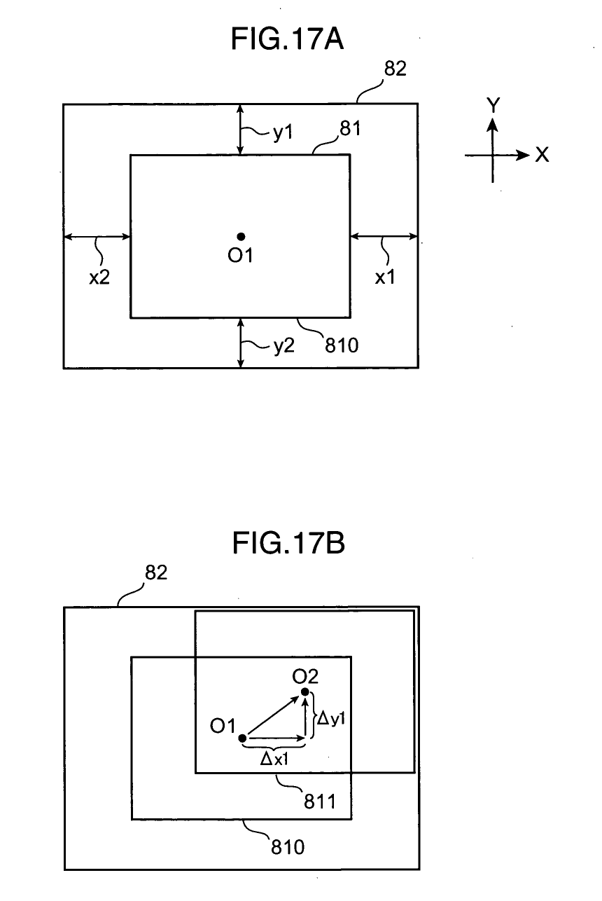

FIGS. 17A and 17B are illustrations for describing a manner as to how the shift amount is calculated by the shift amount calculating section 721. As shown in FIG. 17A, when the imaging area 81 is located in its home position, namely, the centering position corresponding to the first position 810, let it be assumed that distances, namely, movable amounts of the imaging area 81 from the home position to its limit positions in the plus direction and in the minus direction of the X-axis and to its limit positions in the plus direction and in the minus direction of the Y-axis within the sensor moving limit area 82 are x1 and x2, and y1 and y2, respectively. In this case, the moving amount storage 74 stores therein distances corresponding to the distances x1, x2, y1, and y2 in association with the pixel array number of the image sensor 30. For instance, the moving amount storage 74 stores the distance x1 in terms of the pixel array number in the X-axis direction.

In this arrangement, the moving amounts of the image sensor 30 corresponding to the distances x1, x2, y1, and y2 by driving of the X-axis actuator 34 and the Y-axis actuator 35 of the driving mechanism 300 are notified in terms of the pixel array number. If the resolution performance of the X-axis actuator 34 and the Y-axis actuator 35 can be known in terms of the pixel array number, the moving amount of the imaging area 81 of the image sensor 30 in the X-axis direction and in the Y-axis direction can be known in terms of the pixel array number. Generally, the piezoelectric actuator as shown in FIG. 5 has such a resolution performance.

In the case where the imaging area 81 is moved, for instance, from the first position 810 to the upper right corner position, namely, to the second position 811 within the sensor moving limit area 82, the shift amount calculating section 721 calculates the moving amount Ax (where Ax=x1) in the plus direction of the X-axis by driving of the X-axis actuator 34, and the moving amount Ay (where Ay=y1) in the plus direction of the Y-axis by driving of the Y-axis actuator 35 in terms of the pixel array number, whereby the shift amount of the center O2 of the imaging area 81 at the second position 811 relative to the center O1 of the imaging area 81 at the first position 810 is obtained as information relating to the pixel array number. The information for specifying the shift amount is written in the tag information section 673 of the image file 672 for storage in the memory card 67. In this arrangement, in the case where the image captured when the imaging area 81 is located at the first position 810, and the image captured when the imaging area 81 is located at the second position 811 are joined to each other, the two images can be joined to each other at the absolute position by utilizing pixel address information, namely, pixel position information of the image sensor 30 without image displacement or without the need of analysis of the image data of the two images.

The image selecting section 722 is a functional block for selecting images to be joined among the plurality of images captured by the shift photographing operations. The image selecting section 722 allows the user to manually select the images by accepting a manual selection instruction designated by the user through the operating section 64 (see FIG. 8), or is operative to automatically select the images based on a predetermined criteria e.g. the position of the main subject image, which will be described later. Also, the image selecting section 722 discriminates a main image to be used in image synthesis from a sub image corresponding to an extended portion to be added to the main image according to needs.

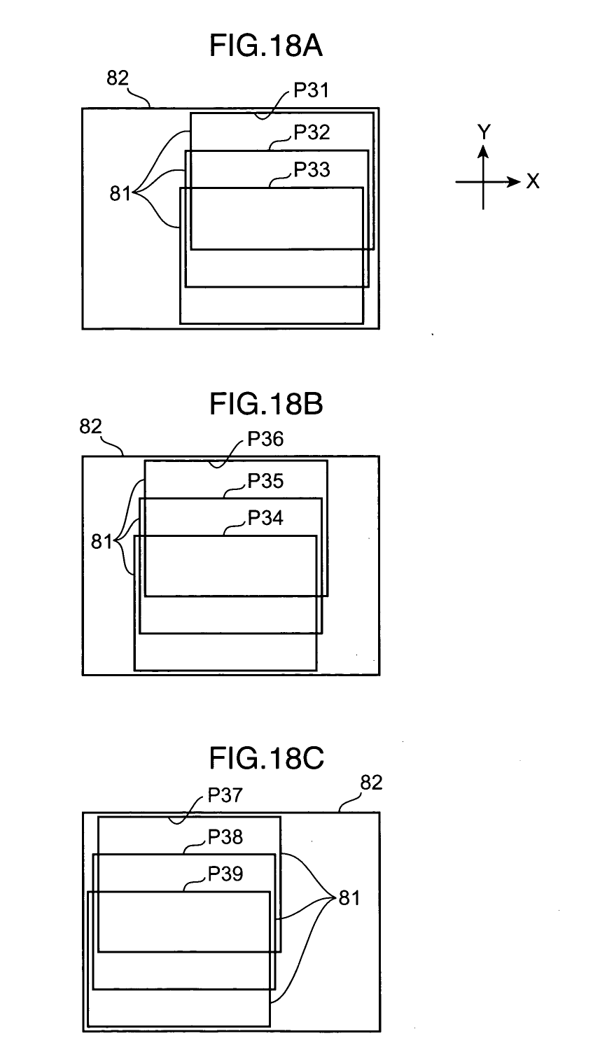

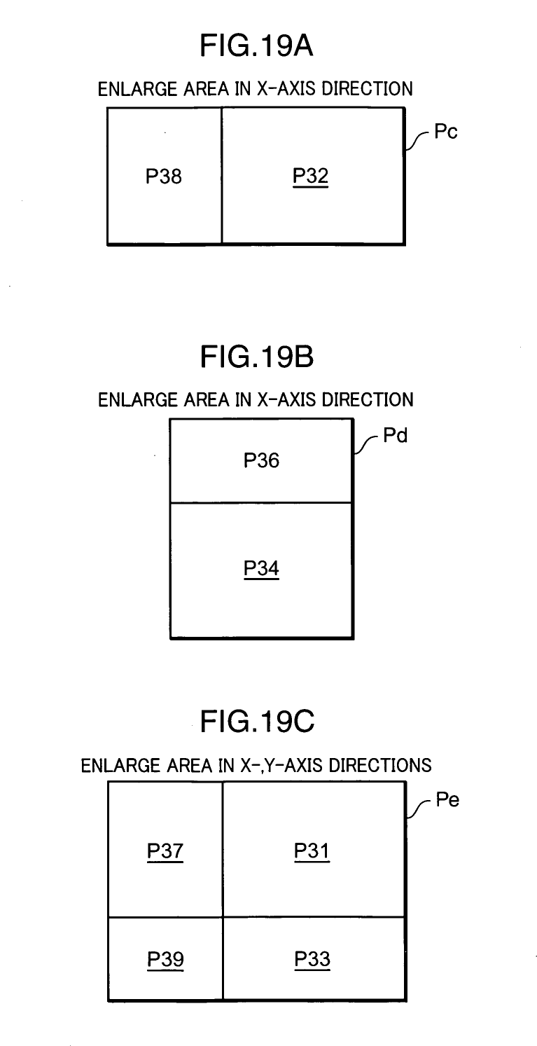

FIGS. 18A through 19C are illustrations for describing the function of the image selecting section 722. FIGS. 18A through 18C show an example that nine images from a first image P31 to a ninth image P39 are obtained by shift photographing operations of the shift photographing controller 71, in which the imaging area 81 is moved stepwise within the sensor moving limit area 82 from the upper right corner position to the lower left corner position in the X-axis direction 3 steps, and in the Y-axis direction 3 steps, namely, 9 steps in total.

In this example, if a panoramic composite image with an imaging area enlarged in the X-axis direction is obtained, as shown in FIG. 19A, two images e.g. the second image P32 and the eighth image P38 are selected. Alternatively, although not illustrated, three images with addition of the fifth image P35 may be selected. Alternatively, the first image P31 and the seventh image P37 may be selected, or additionally the sixth image P36 may be selected. Further alternatively, the third image P33 and the ninth image P39 may be selected, or additionally the fourth image P34 may be selected. In the case where two or three images arrayed in the X-axis direction are selected by the image selecting section 722, the image synthesis processing section 725, which will be described later, creates a panoramic composite image Pc by using the selected images. In FIG. 19A, the composite image Pc is illustrated, wherein the eighth image P38 is added to the second image P32. In other words, the composite image Pc is constituted of the second image P32 as a main image, and the eighth image P38 as a sub image. However, the manner as to how the images are joined is arbitrarily set. A composite image may be obtained by using the eighth image P38 as a main image and the second image P32 as a sub image, or may be obtained by joining the second image P32 and the eighth image P38 with an equal area to each other. The same idea is applicable to the following techniques.

If a composite image of a shape similar to a square, with an imaging area enlarged in the Y-axis direction is created, as shown in FIG. 19B, two images e.g. the fourth image P34 and the sixth image P36 are selected. Alternatively, although not illustrated, three images with addition of the fifth image P35 may be selected. Alternatively, the first image P31 and the third image P33 may be selected, or the second image P32 may be additionally selected. Further alternatively, the seventh image P37 and the ninth image P39 may be selected, or the eighth image P38 may be additionally selected. In the case where two or three images arrayed in the Y-axis direction are selected by the image selecting section 722, the image synthesis processing section 725 creates a composite image Pd of a shape similar to a square by using the selected images.

Also, in the case where a composite image of a full size, with an imaging area enlarged in the X-axis direction and in the Y-axis direction is created, as shown in FIG. 19C, four images e.g. the first image P31, the third image P33, the seventh image P37, and the ninth image P39 are selected. Alternatively, although not illustrated, five or more images may be selected by adding one or more images to the first image P31, the third image P33, the seventh image P37, and the ninth image P39. Alternatively, all the images, namely, the first to the ninth images P31 through P39 may be selected. In this way, when at least four images at the four corner positions on the sensor moving limit area 82 are selected by the image selecting section 722, the image synthesis processing section 725 creates the composite image Pe of a full size by using the selected images.

The main subject specifying section 723 is a functional block for specifying the position of the main subject image based on the subject optical image. The main subject specifying section 723 sets a three-dimensional coordinate system, in which a distance to the subject image is defined in Z-axis perpendicularly intersecting the imaging plane of the image sensor 30 by utilizing metering information acquired for focus control, for instance, and creates a three-dimensional distance image representing the subject distance by plotting the subject distances corresponding to respective metered points in the three-dimensional coordinate system. In the case where the main subject is a person, the person and its position on the imaging plane of the image sensor 30 are detected by using the distance image, based on a ratio of the face width to the trunk body width of an actual human, or the like.

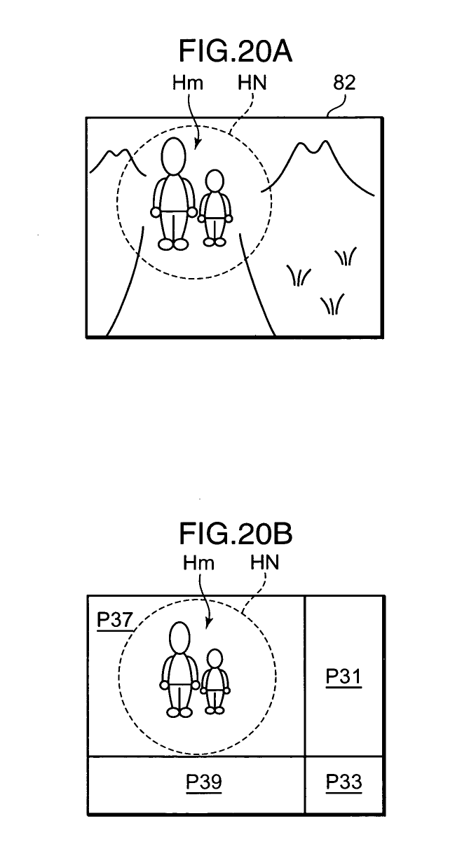

The image selecting section 722 automatically selects images to be joined in such a manner that a joined portion of the selected images to be joined may not be located in the vicinity of the main subject image specified by the main subject specifying section 723 in the case where designation to utilize the information relating to the position of the main subject image has been entered. FIGS. 20A and 20B are illustrations for describing the automatic selection. The following is an example, in which shift photographing of moving the image sensor 30 in nine steps as shown in FIGS. 18A through 18C is performed to obtain the first through the ninth images P31 through P39 in the case where an image of a person, which is supposed to be a main subject image Hm, is located in the sensor moving limit area 82, and the full-size composite image Pe as shown in FIG. 19C is created.

An image defect may likely to occur in a joined portion of a composite image where images are joined to each other. If such a joined portion exists in a vicinity area (hereinafter, called as a “main subject vicinity area HN”) of the area where the main subject image Hm is located, there is a case that an image captured area representing the main subject image Hm may include a streak or an image distortion. In view of this, the image selecting section 722 selects the seventh image P37 which completely covers the main subject vicinity area HN specified by the main subject specifying section 723, as a main image, and selects the first image P31, the third image P33, and the ninth image P39 as sub images. This arrangement enables to create a composite image, with the joined portion being excluded from the main subject vicinity area HN, whereby high quality image photographing is secured for the main subject image Hm.

The defect pixel interpolation controlling section 724 causes the pixel interpolation circuit 612 to perform defect pixel interpolation with respect to a raw image before plural images obtained by the shift photographing operations are joined to each other while the shift photographing mode is executed. A process of specifying a defect pixel based on the pixel address information is essential for pixel interpolation. Determining the defect pixel is difficult if interpolation of the defect pixel is attempted after image synthesis. In view of this, the defect pixel interpolation controlling section 724 causes the pixel interpolation circuit 612 to interpolate a defect pixel prior to image synthesis with respect to each of the images obtained by the shift photographing operations. This arrangement enables to speed up the defect pixel interpolation.

The image synthesis processing circuit 725 reads out, from the memory card 67, the image files which have been stored in the memory card 67 in correlation to each other for creation of a composite image, creates a composite image by performing a synthesizing process with use of the image files or image files relating to the images selected by the image selecting section 722, and stores the created composite image in the memory card 67 as a single image file. The positional relation between the images used for the image synthesis is determined based on the pixel array number information obtained by the shift amount calculating section 721. In other words, the shift amounts of the images to be joined are determined in terms of the pixel array number, and the images captured by the shift photographing are joined to each other at the absolute position based on the information forspecifying the shift amounts of the respective images.

The drive pattern storage 73 stores therein the drive pattern according to which the image sensor 30 is sequentially moved to the different positions in the predetermined order by the driving mechanism 300. The drive pattern is the ones as exemplified in FIGS. 12A through 12D, and FIGS. 13A through 13E. The continuous photographing controlling section 712 reads out the information relating to the drive pattern from the drive pattern storage 73 while the digital camera 1 is in the shift photographing mode, controls the driving mechanism 300 to move the image sensor 30 sequentially to the different positions in accordance with the drive pattern, and causes the image sensor 30 to perform a series of image capturing operations at the respective positions.

The moving amount storage 74 stores therein the movable amounts of the image sensor 30 in the X-axis direction, namely, in the first axis direction and in the Y-axis direction, namely, in the second axis direction relative to the home position thereof in correlation to the pixel array number of the image sensor 30. The information stored in the moving amount storage 74 is read out by the shift amount calculating section 721, and is utilized in a process of calculating the shift amounts of the images in the X-axis direction and in the Y-axis direction in terms of the pixel array number.

(Description on Imaging Process by Digital Camera)

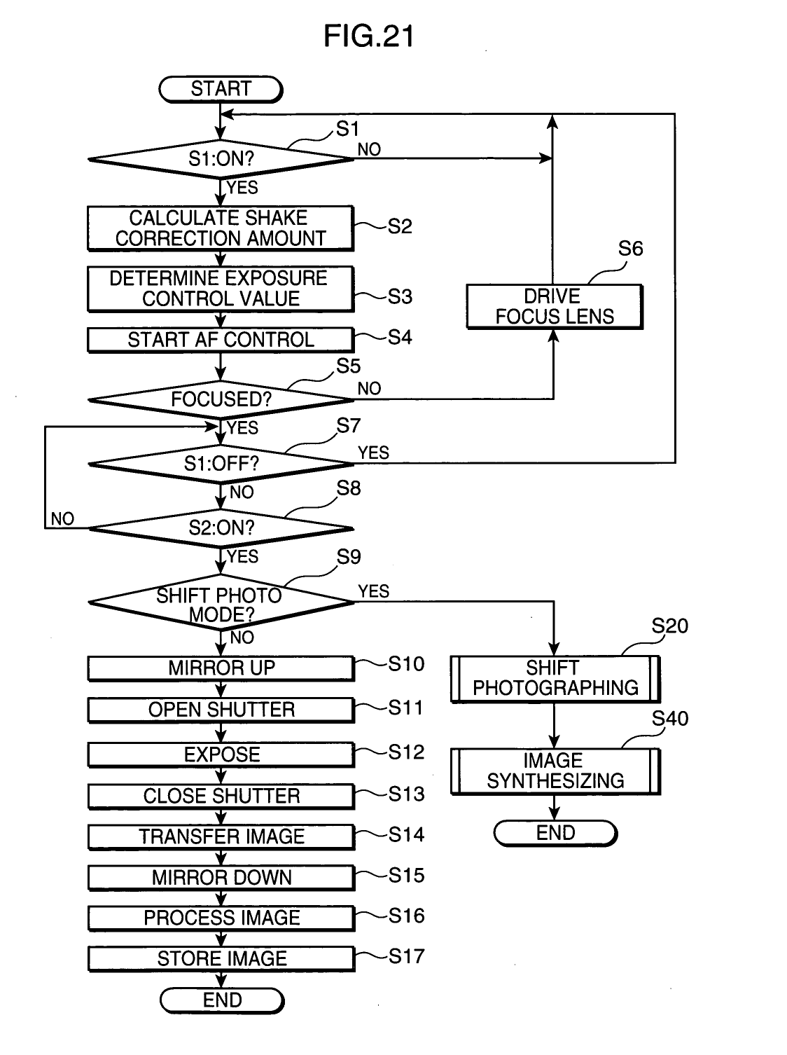

Next, a sequence of an imaging process by the digital camera 1 in the embodiment is described referring to FIG. 21, as well as FIGS. 1 through 9 according to needs. FIG. 21 is a flowchart showing the imaging process. When the digital camera 1 starts up, the main controller 62 judges whether the shutter button 13 is brought to a halfway pressed state, namely, the switch S1 is turned on (Step S1). If the shutter button 13 is judged not to be brought to a halfway pressed state (NO in Step S1), the routine waits until the shutter button 13 is brought to a halfway pressed state. If the shutter button 13 is judged to be brought to a halfway pressed state (YES in Step S1), the anti-shake controller 622 in the main controller 62 calculates a shake correction amount based on a shake detection result from the anti-shake sensor 49 (Step S2).

Then, the main controller 62 determines an exposure control value such as a shutter speed and an aperture value based on a luminance of a subject image (Step S3), and starts an auto-focus control according to a phase difference detection system (Step S4). The AF controller 621 in the main controller 62 judges whether the focusing has been completed (Step S5). If the focusing has not been completed (NO in Step S5), the focus lens element 211 is driven based on the driving direction and the driving amount determined by the focus adjustment or the auto-focus control in Step S4 (Step S6), and the routine returns to the operation in Step S1 to repeat the operations thereafter.

If the focusing has been completed (YES in Step S5), the main controller 62 judges the operative state of the shutter button 13. Specifically, the main controller 62 judges whether the halfway pressed state of the shutter button 13 is released (Step S7). If the shutter button 13 is judged to be released from the halfway pressed state (YES in Step S7), the routine returns to the operation in Step S1. If the shutter button 13 is judged not be released from the hallway pressed state (NO in Step S7), then, it is judged whether the shutter button 13 is brought to a fully pressed state, namely, the switch S2 is turned on (Step S8). If the shutter button 13 is judged not to be brought to a fully pressed state (NO in Step S8), the routine goes back to the operation in Step S7.

On the other hand, if the shutter button 13 is judged to be brought to a fully pressed state (YES in Step S8), the main controller 62 judges whether the digital camera 1 is set to the shift photographing mode (Step S9). If it is judged that the digital camera 1 is in the normal photographing mode, namely, is not set to the shift photographing mode (NO in Step S9), the main controller 62 drives the mirror driving actuator 44M via the mirror driving controller 44A in such a manner that the quick return mirror 441 and the sub mirror 442 are set to their respective horizontal positions (so-called “mirror-up position”) (Step S10). At this stage, the main controller 62 sets the image sensor 30 and the AFE 5 to a state that the power is supplied from the power source circuit 69, thereby energizing the image sensor 30. At this time, the driving mechanism 300 starts to drive the image sensor 30 for anti-shake control.

Next, the main controller 62 controls the shutter driving controller 43A and the shutter driving actuator 43M to open the shutter unit 43 (Step S11), and causes the image sensor 30 to perform an image capturing operation, namely, an exposure operation in a state that the focus lens element 211 is set to the position defined in Step S5, and with an exposure control value set in Step S3 (Step S12).

Thereafter, the main controller 62 controls the shutter driving controller 43A and the shutter driving actuator 43M to close the shutter unit 43 (Step S13) to terminate the exposure operation. At this time, the anti-shake driving of the image sensor 30 by the driving mechanism 300 is terminated. Then, transfer of an image signal obtained by the exposure operation is started from the image sensor 30 to the image processor 61 via the AFE 5 (Step S14). Also, the main controller 62 controls the mirror driving actuator 44M to set the quick return mirror 441 and the sub mirror 442 to their respective tilt positions (so-called “mirror-down position”) (Step S15). The digital image signal transferred to the image processor 61 is temporarily stored in the image memory 615. When the image signal transfer with respect to all the pixels of the image sensor 30 is completed, the power supply from the power source circuit 69 to the image sensor 30 and to the AFE 5 is terminated.

Next, the main controller 62 causes the image processor 61 to execute image processing such as black level correction, defect pixel interpolation, white balance adjustment, and gamma correction (Step S16). Thereafter, the processed image is subjected to a compression process, and the compressed image data is recorded in the memory card 67 (Step S17). On the other hand, if the shift photographing mode is set (YES in Step S9), a shift photographing operation (Step S20) and an image synthesizing operation (Step S40), which will be described later, are performed successively. This is a sequence of the imaging process to be implemented by the digital camera 1.

(Description on Shift Photographing and Image Synthesizing Operations)

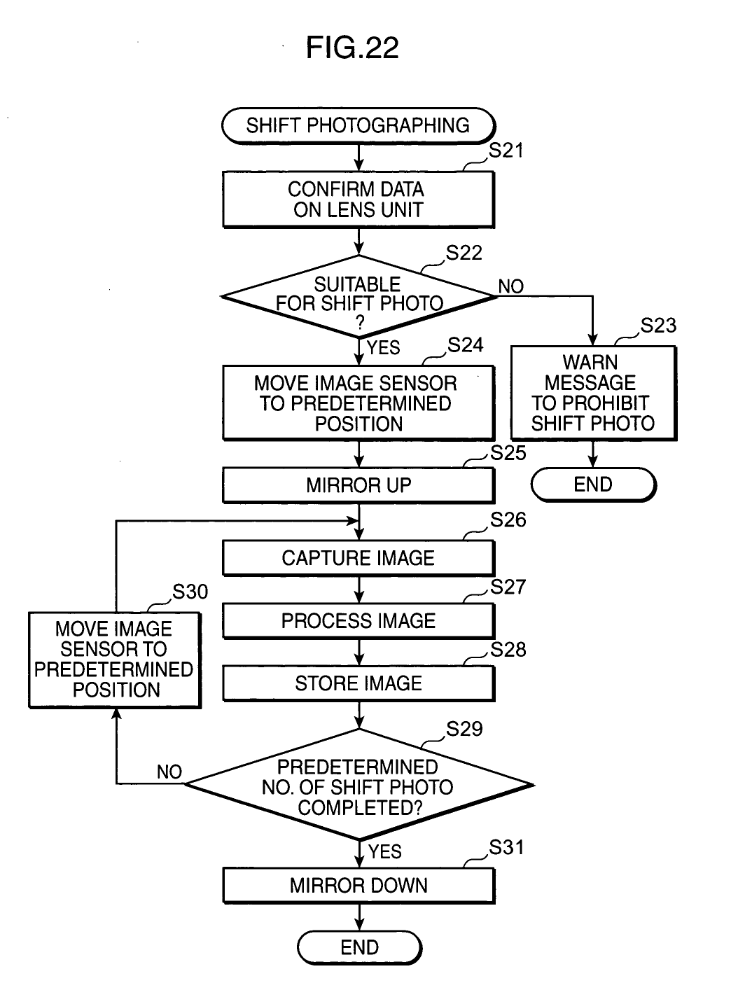

Next, the shift photographing operation and the image synthesizing operation, namely, the operations in Steps S20 and S40 in the flowchart of FIG. 21, which are executed in response to receiving a control signal from the area enlarge controller 623 in the main controller 62, are described referring to FIGS. 22 through 24. FIG. 22 is a flowchart showing a flow of the shift photographing operation. In this embodiment, described is a case that the mode of sequentially and automatically moving the image sensor 30, namely, the mode in which the continuous photographing controlling section 712 functions, is executed.

When the shift photographing mode starts, the photographing prohibit controlling section 714 in the shift photographing controller 71 acquires data from the lens controller 26 in the lens unit 2 mounted on the digital camera 1, and confirms information relating to the image circle IC of the lens unit 2 (Step S21). The photographing prohibit controlling section 714 judges whether a lens unit having an exceedingly small image circle IC such as an APS-lens unit is mounted (Step S22). If it is judged that the lens unit not-suitable or incapable of performing shift photographing is mounted (NO in Step S22), a warning message that shift photographing is prohibited such as “SHIFT PHOTO NOT EXECUTABLE” is displayed on the LCD 14 (Step S23). Thus, the routine ends.

If it is judged that the lens unit 2 is suitable or capable of performing shift photographing (YES in Step S22), the continuous photograph controlling section 712 in the shift photographing controller 71 controls the driving mechanism 300 to move the image sensor 30 to a predetermined position, namely, to the first position for performing a shift photographing operation for the first time (Step S24). For instance, in the case that a series of shift photographing operations as shown in FIGS. 18A through 18C are performed, the image sensor 30 is moved to the upper right corner position to obtain the first image P31. If the image sensor 30 is located at the centering position, and the first shift photographing operation is performed at the centering position, step S24 is omitted.

Thereafter, the main controller 62 controllably sets the quick return mirror 441 and the sub mirror 442 to their respective horizontal positions, namely to the mirror-up position (Step S25), and controls an image capturing operation including opening of the shutter unit 43, exposing, closing of the shutter unit 43, and an image transfer (Step S26). The operation in Step S26 corresponds to the operations in Steps S11 through S14 in the flowchart shown in FIG. 21.

Next, the image processor 61 applies a predetermined image processing to the captured image (Step S26). At this time, the defect pixel interpolation controlling section 724 controls the pixel interpolation circuit 612 to perform interpolation of a defect pixel prior to an image synthesizing operation. Then, the image after the image processing is recorded in the memory card 67 (Step S28). At this time, as shown in FIG. 15, the image record controlling section 713 records tag information necessary for correlating images acquired by the series of shift photographing operations to each other in the tag information section 673 so that a composite image is creatable by joining the images.

Subsequently, the continuous photograph controlling section 712 confirms whether a predetermined number of shift photographing operations has been completed. In other words, it is confirmed whether all the steps in the drive pattern stored in the drive pattern storage 73 have been executed (Step S29). If it is judged that the predetermined number of shift photographing operations has not been completed (NO in Step S29), the continuous photograph controlling section 712 controls the driving mechanism 300 to move the image sensor 30 to the second position for performing the second shift photographing operation, with the quick return mirror 441 and the sub mirror 442 retained at the mirror-up position (Step S30). Then, the routine performs the operations from Step S26 through S28. This loop is repeated by the predetermined number corresponding to the number of the series of shift photographing operations.

On the other hand, if the predetermined number of shift photographing operations has been completed (YES in Step S29), the main controller 62 controllably sets the quick return mirror 441 and the sub mirror 442 to their respective tilt positions, namely, the mirror-down position (Step S31). Thus, the routine ends.

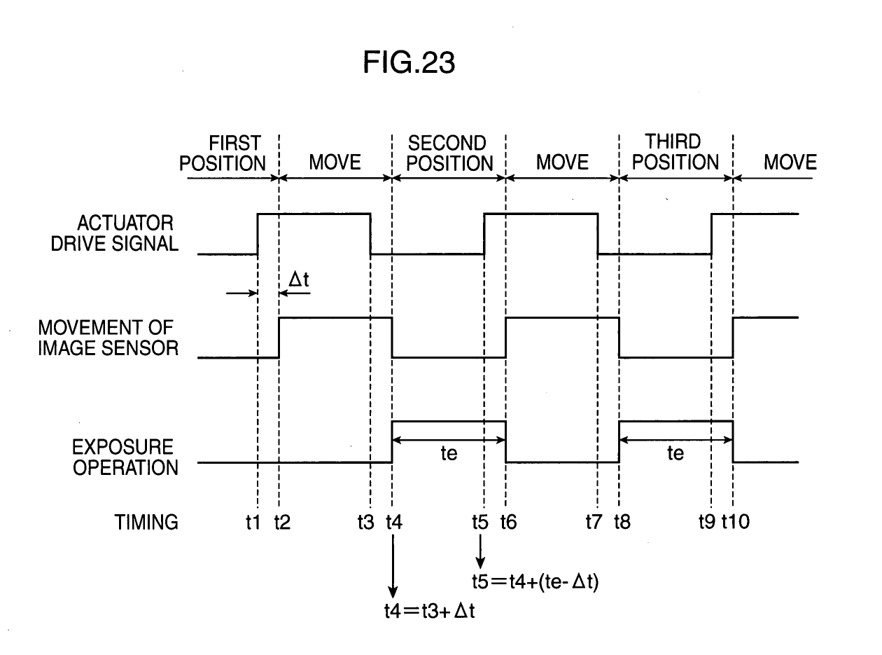

Now, a preferred process of controllably moving the image sensor 30 by the continuous photograph controlling section 712 is described referring to the timing chart shown in FIG. 23. Generally, there is a time lag between a timing of outputting a drive signal to the X-axis actuator 34 and to the Y-axis actuator 35 of the driving mechanism 300, and a timing of actually starting or suspending moving of the movable base plates, namely, the second base plate 32 and the third base plate 33 by the driving mechanism 300. In the shift photographing mode, the movement of the image sensor 30 has to be suspended during an exposure operation. However, without consideration of the time lag, it is highly likely that an exposure operation may be started while the image sensor 30 is moved, or a time corresponding to the time lag may be wasted. In view of this, it is desirable to control movement of the image sensor 30 as shown in the timing chart of FIG. 23.

Assuming that the image sensor 30 is located at the first position, and an actuator drive signal is outputted to the X-axis actuator 34 and to the Y-axis actuator 35 of the driving mechanism 300 at the timing t1, the image sensor 30 starts to move from the first position to the second position at the timing t2 after lapse of a time lag Δt from the timing t1.

The output of the actuator drive signal is suspended at the timing t3. However, movement of the image sensor 30 is not suspended immediately at the timing t3. The image sensor 30 is stopped at the second position at the timing t4 after lapse of the time lag Δt from the timing t3. In light of this moving property or the time lag of the image sensor 30, the continuous photograph controlling section 712 controls the image sensor 30 to start an exposure operation at the timing t4 (=t3 +Δt) where t3 is the reference timing, and Δt is a time lag to be added to the reference timing t3.

An exposure time te is determined by an AE controller. The continuous photograph controlling section 712 acquires the information relating to the exposure time te, and specifies the timing t6, which is an end time of the exposure operation. The continuous photograph controlling section 712 outputs, to the driving mechanism 300, an actuator drive signal, which causes the image sensor 30 to move from the second position to the third position at the timing t5 (=t4+(te−Δt)), which is earlier than the reference timing t6 by the time lag Δt. Thereby, the exposure time te ends at the timing t6, and the image sensor 30 starts to move from the second position to the third position at the timing t6.

Similarly to the above, the continuous photograph controlling section 712 suspends output of the actuator drive signal at the timing t7, and causes the image sensor 30 to start an exposure operation at the timing t8 at which the image sensor 30 is stopped at the third position. The continuous photograph controlling section 712 outputs, to the driving mechanism 300, an actuator drive signal for moving the image sensor 30 from the third position to the fourth position at the timing t9, which is earlier than the timing t10 corresponding to the end timing of the exposure time te by the time lag Δt. In this way, the shift photographing can be performed by accurately moving the image sensor 30 without an image blur or a waste of time by outputting the actuator drive signal at the adequate timing considering the time lag.

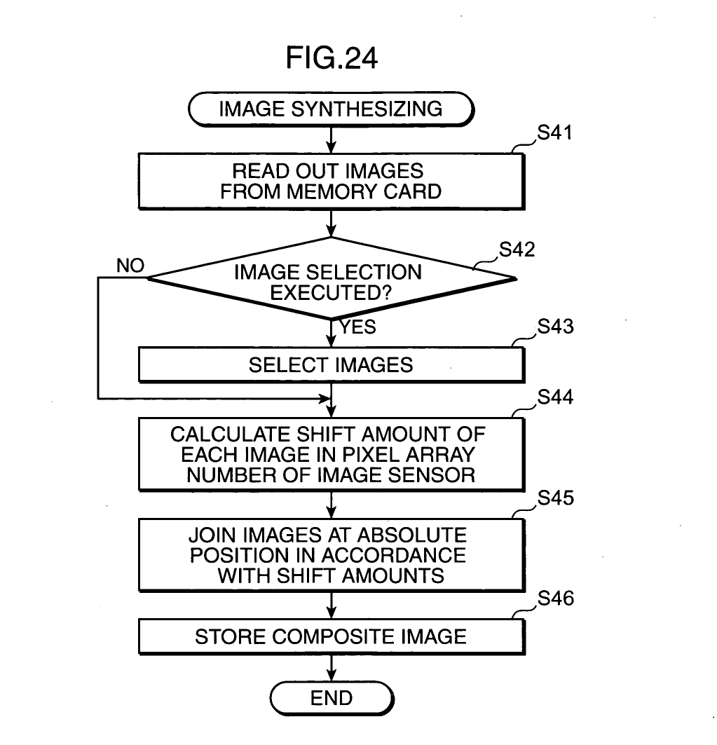

FIG. 24 is a flowchart showing a flow of the image synthesizing operation to be implemented by the image synthesis controller 72 (see FIG. 9). When the image synthesizing operation starts upon receiving an instruction signal of image synthesis or the like from the operating section 64, the image synthesis controller 72 reads out the image file from the memory card 67, and reads out the images acquired by the series of image capturing operations in the shift photographing operations, based on the recorded information in the tag information section 673 (see FIG. 15) (Step S41).

Subsequently, it is confirmed whether an image selection is to be executed by the image selecting section 722 (Step S42). If a manual image selection instruction is given, or if execution of image selection based on a main subject information from the main subject specifying section 723 is designated (YES in Step S42), images for use in image synthesis are selected from the readout image group (Step S43). In this step, selection as to which image is used as a main image in joining the images, namely, information relating to image synthesis designation is also received. If, on the other hand, an instruction relating to the image selection, or an instruction as to selection of a main image has not been given (NO in Step S42), the routine skips step S43. In this case, a default image e.g. an image when the image sensor 30 is located at the centering position is adopted as the main image.

Then, the shift amount calculating section 721 calculates the shift amount between the images to be joined in terms of the pixel array number of the image sensor 30 (Step S44). The information relating to the pixel array number for specifying the position of the image sensor 30, which is stored in the tag information section 673 of each image file, is used for calculation of the shift amount.

Thereafter, the image synthesis processing section 725 joins the images obtained by the series of shift photographing operations at the absolute position in accordance with the shift amount, based on the information relating to the pixel array number, the information relating to the position of the main subject image, namely, the information relating to image synthesis designation, and the like to create a composite image (Step S45). The image synthesis processing section 725 causes the image processor 61 to apply an adequate image processing to the composite image, and records the processed composite image in the memory card 67 or in the image memory 615 as a composite image file, thus completing the image synthesizing operation (Step S46).

In the digital camera 1 having the above arrangement, the first image and the second image obtained by moving the image sensor 30 to the different positions and by causing the image sensor 30 to perform image capturing operations at the respective positions are stored in the memory card 67 in correlation to each other so that a composite image is creatable by joining the first image and the second image. In this arrangement, an intended composite image can be created by using the first image and the second image. A composite image substantially equivalent to an image captured by an image sensor of an increased number of pixels is obtained. For instance, a composite image substantially equivalent to an image captured by a large-size image sensor e.g. a CCD color area sensor of a film size can be obtained with use of an inexpensive image sensor of general use e.g. a CCD color area sensor of APS size. Also, even if the size of the image sensor is restricted due to constraints such as a space for assembling parts, a megapixel image can be obtained without minimizing the pixel pitch of the image sensor.

Further, since shift photographing is performed by moving the image sensor 30 in a direction orthogonal to the optical axis, shift photographing can be performed irrespective of the kind of the photographing optical system mounted on the digital camera 1, without the need of providing a shift lens in the photographing optical system. Further, this arrangement is advantageous in creating a fine composite image without an influence of lens aberration.

(Description on Modification)

The embodiment of the invention has been described above. The invention is not limited to the foregoing, and the following modifications (1) through (8) may be applied in addition to or in place of the embodiment.

(1) In the embodiment, the moving function of the image sensor 30 by the driving mechanism 300 is commonly used as the function of the anti-shake mode, and the function of the shift photographing mode. Alternatively, either one of the anti-shake mode and the shift photographing mode may be selectively executed. Specifically, it is possible to execute the shift photographing mode, with the anti-shake mode being executed. However, it is possible to prohibit execution of one of the anti-shake mode and the shift photographing mode while the other one of the anti-shake mode and the shift photographing mode is executed. Thereby, the moving control of the image sensor 30 can be simplified. Further alternatively, loading of the anti-shake function may be eliminated. Also, the anti-shake function may be executed by arranging a shift lens or an equivalent lens in the photographing optical system or the lens group 21.

(2) In the embodiment, a technique of joining the images at the absolute position based on the information relating to the pixel array number of the image sensor 30 is described as an example of image synthesizing techniques. It is possible to adopt various well-known image synthesizing techniques. For instance, it is possible to obtain information relating to a difference in position between images to be joined by displacing the images one from the other two-dimensionally by several dots or pixels, and to join the images at such a position that the difference is minimal.

(3) The moving range of the image sensor 30 can be set arbitrarily. In the embodiment, described is a case that the moving range of the image sensor is relatively narrow. Alternatively, the image sensor 30 may be configured to be movable by the distance corresponding to the vertical size of the image sensor 30 or by the distance corresponding to the horizontal size thereof In such an altered arrangement, a full-size composite image of 30.0 mm×23.5 mm can be created by disposing an APS image sensor of 15.7 mm×23.5 mm with the longer side thereof directed in the vertical direction, obtaining two frames of images by shift photographing operation of moving the image sensor in a direction parallel to the shorter side of the image sensor by a distance substantially corresponding to the shorter side hereof, and by joining the images to each other. In other words, an image substantially equivalent to an image captured by an expensive full-size image sensor can be obtained by the inexpensive APS image sensor.

(4) In the embodiment, a piezoelectric actuator is used as an actuator in the driving mechanism 300. Alternatively, it is possible to use an actuator such as a stepping motor and a moving coil. Further alternatively, it is possible to use a spring charge mechanism as employed in the quick return mirror 441 to make the image sensor movable by a long distance at a high speed

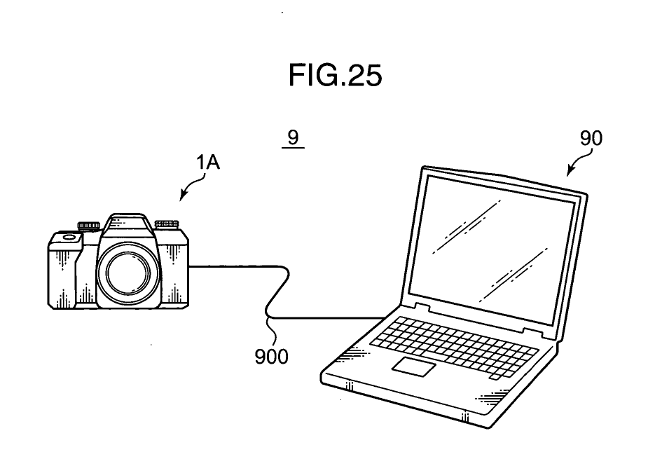

(5) In the embodiment, the image synthesizing function, namely, the image synthesis controller 72 is equipped in the digital camera 1. As shown in FIG. 25, an imaging system 9 may be configured by connecting a digital camera 1A and a personal computer 90 as a processor by a communications cable 900, and an image synthesizing process may be executed by the personal computer 90.

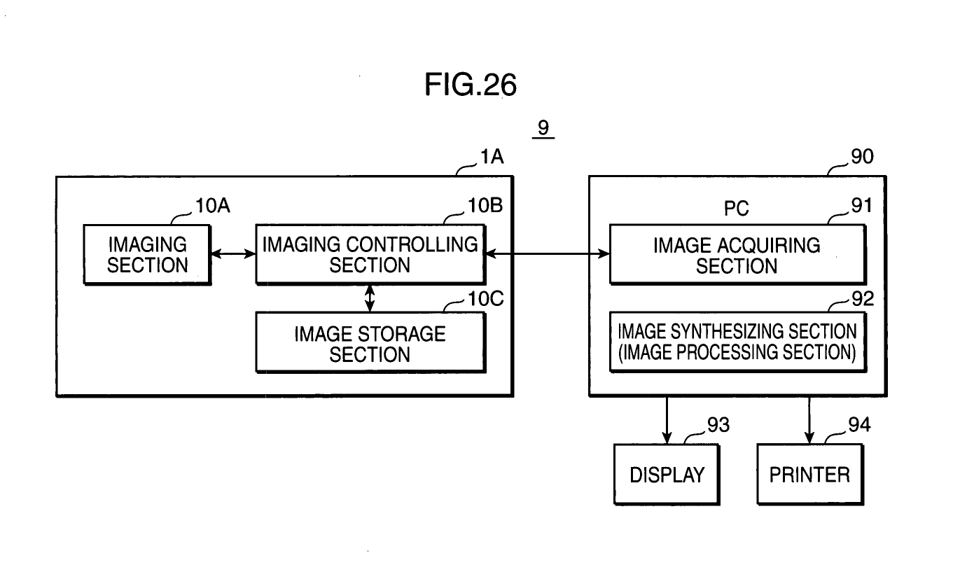

FIG. 26 is a block diagram showing a functional arrangement of the imaging system 9. In this arrangement, the digital camera 1A includes an imaging section 10A, an imaging controlling section 10B, and an image storage section 10C. The imaging section 10A corresponds to the image sensor 30 and the driving mechanism 300 in the embodiment. The imaging controlling section 10B corresponds to the shift photograph controlling section 71. The image storage section 10C corresponds to the memory card 67. The personal computer 90 includes an image acquiring section 91 for acquiring an image file stored in the image storage section 10C, and an image synthesizing section 92 or an image processing section for synthesizing the images acquired by the image acquiring section 91. The image synthesizing section 92 corresponds to the image synthesis controller 72 in the embodiment.

According to the imaging system 9, various sophisticated image processing and image synthesis can be performed by the personal computer 90, with use of the images acquired in the shift photographing mode of the digital camera 1A. The personal computer 90 may be connected with a display 93 and/or the printer 94.

(6) It is possible to interconnect a recording medium recorded with an image file obtained by shift photographing to a drive of the personal computer 90, or to accept transfer of an image file obtained by shift photographing from a server device or other personal computer via a predetermined communications line, in place of directly connecting the personal computer 90 to the digital camera 1A.

(7) The digital camera 1 of a single reflex lens type is illustrated as an example of the image sensing apparatus in the embodiment. The present invention is applicable to a digital camera of a type other than the single reflex lens type, and an image sensing apparatus for measurement.

(8) It is possible to provide an operation program of executing a process to be implemented by the digital camera 1 or the imaging system 9, as an embodiment to carry out the invention. The program may be provided as a program product by recording the program on a computer-readable recording medium, which is an attachment to a computer, such as a flexible disk, a CD-ROM, an ROM, an RAM, or a memory card. Also, the program may be provided by downloading via a network.

As described above, a novel image sensing apparatus comprises: an image sensor which converts a subject optical image into an electrical signal; a driving section which moves the image sensor on a plane orthogonal to an optical axis of the image sensing apparatus; an imaging controlling section which causes the image sensor to obtain a first image and a second image, the first image being obtained by causing the image sensor to perform an image capturing operation with the image sensor being located at a first position, and the second image being obtained by causing the image sensor to perform an image capturing operation after the image sensor being moved to a second position different from the first position by driving of the driving section; and a storage which stores the first image and the second image in correlation to each other so that a composite image is creatable by joining the first image and the second image.

In the above arrangement, the first image and the second image are obtained sequentially, wherein the first image is obtained in a state that the image sensor is located at the first position, and the second image is obtained in a state that the image sensor is located at the second position by driving of the driving section. Specifically, unlike a conventional arrangement that part of lens elements constituting a photographing optical system is moved for an image capturing operation, an image capturing operation is performed by moving the image sensor itself. Hereinafter, this image capturing operation is sometimes called as “shift photographing”. The first and second images are stored in the storage in correlation to each other so that the composite image is creatable by joining the first image and the second image, which enables to create an intended composite image by using the first image and the second image.

In the image sensing apparatus having the above arrangement, the first image and the second image obtained by moving the image sensor for shift photographing are stored in the storage in correlation to each other so that the composite image is creatable by joining the first image and the second image. In this arrangement, an intended composite image can be created by using the first and second images. A composite image substantially equivalent to an image captured by an image sensor having pixels of an increased number is obtained. For instance, a composite image substantially equivalent to an image captured by a large-size image sensor, e.g., a CCD color area sensor of a film size can be obtained with use of an inexpensive image sensor of general use, e.g., a CCD color area sensor of APS size. Also, even if the size of the image sensor is restricted due to constraints such as a space for assembling parts, a megapixel image can be obtained without minimizing the pixel pitch of the image sensor.

Further, since shift photographing is performed by moving the image sensor in the direction orthogonal to the optical axis, the shift photographing can be performed irrespective of the kind of the photographing optical system mounted on the image sensing apparatus, without the need of providing a shift lens in the photographing optical system. Further, this arrangement is advantageous in creating a fine composite image without an influence of lens aberration.

Preferably, it may be appreciated to further provide the image sensing apparatus with an image synthesizing section which creates the composite image by joining the first image and the second image.

In the above arrangement, an image synthesis of joining the first image and the second image is executed by the image sensing apparatus alone without use of an external processing device such as a personal computer, which enables to enhance user's operability.

It may be preferable that the image synthesizing section joins the first image and the second image by specifying a positional relation between the first image and the second image based on pixel position information of the image sensor.

In the above arrangement, the first image and the second image can be joined to each other at the absolute position based on the pixel position information of the image sensor, without depending on a technique of analyzing image data of the first image and the second image for joining the first image and the second image. This arrangement enables to simplify the image synthesizing process, and to execute image joining at a high speed.

It may be preferable that the image sensor is movable in a first axis direction and in a second axis direction orthogonal to the first axis direction on the plane orthogonal to the optical axis, and the image sensing apparatus is further provided with a moving amount storage which stores information relating to a movable amount of the image sensor relative to a predetermined home position of the image sensor in the first axis direction and in the second axis direction in association with a pixel array number of the image sensor, and the image synthesizing section specifies a shift amount of the second image relative to the first image by calculating a moved amount of the image sensor in the first axis direction and/or the second axis direction by driving of the driving section in terms of the pixel array number of the image sensor based on the information stored in the moving amount storage, and creating the composite image by joining the first image and the second image based on the specified shift amount.

In the above arrangement, the shift amount of the second image relative to the first image can be obtained in terms of the pixel array number of the image sensor, and the first image and the second image can be easily joined to each other based on the information relating to the pixel array number of the image sensor. This arrangement enables to perform an image synthesis without the need of elaborate computation as required in analyzing image data of the first image and the second image for joining the first image and the second image.

It may be preferable that the image sensor is a rectangular image sensor, and is movable in a first axis direction parallel to a vertical side of the image sensor, and in a second axis direction parallel to a horizontal side of the image sensor on the plane orthogonal to the optical axis, and the imaging controlling section selects a position obtained by moving the image sensor in the first axis direction or in the second axis direction by a certain amount in parallel thereto relative to the first position, as the second position, and causes the image sensor to perform an image capturing operation at the second position to obtain the second image, and the image synthesizing section is so configured as to create the composite image having an aspect ratio different from an aspect ratio of the image sensor by joining the first image and the second image.

In the above arrangement, the composite image having the intended aspect ratio can be created, without depending on the aspect ratio of the image sensor, which enables to enhance user's operability.

It may be preferable that the image synthesizing section includes a selecting section which selects images to be joined among the images obtained by the imaging controlling section.

In the above arrangement, images satisfying a predetermined standard can be automatically selected, or images desired by the user can be manually selected with use of the selecting section among the images acquired by moving the image sensor for shift photographing. In this way, the selecting section is operative to select the suitable images among the plural images acquired by moving the image sensor for shift photographing, which makes it possible to create a composite image suitable for a photographic scene, or a composite image desired by the user.

It may be preferable to further provide a main subject specifying section which specifies the position of a main subject image, and permit the selecting section to select the images to be joined in such a manner that a joined portion of the images is eliminated from an area in the vicinity of the specified main subject image.

An image defect is likely to occur in a joined portion of a composite image where images are joined to each other. In view of this, the main subject image specifying section specifies the position of the main subject image, and a high-quality main subject image is secured by selecting the images so that the joined portion may be excluded from the area in the vicinity of the main subject image. This arrangement enables to obtain a fine composite image.

It may be preferable that the image synthesizing section performs a defect pixel interpolation with respect to each of the first image and the second image prior to the joining of the first image and the second image.

In the above arrangement, the defect pixel interpolation is performed with respect to each frame image, which is advantageous in the aspect of processing easiness, as compared with an arrangement that defect pixel interpolation is performed after image synthesis. Thereby, high speed processing can be achieved, with accurate defect pixel interpolation being secured.

It may be preferable that the image sensing apparatus is further provided with a drive pattern storage which stores a drive pattern according to which the image sensor is moved to predetermined plural positions sequentially according to a predetermined order by the driving section, and the imaging controlling section controls the driving section to move the image sensor to the predetermined positions sequentially based on the drive pattern, and causes the image sensor to perform a series of image capturing operations at the respective positions in response to receiving an operation signal.

In the above arrangement, the image sensor is sequentially moved to the predetermined positions based on the predetermined drive pattern in response to pressing of a shutter button, for instance, and the images are acquired sequentially. In this way, an intended shift photographing can be executed as a series of operations in response to pressing of the shutter button. This arrangement enables to reduce a burden of the user in operating the image sensing apparatus for shift photographing, and to precisely acquire shift photographed images.

It may be preferable that in a case that there is a time lag between a timing at which a drive signal is outputted to the driving section and a timing at which the driving section starts movement of the image sensor in response to the drive signal, the imaging controlling section controls the image sensor to start an exposure operation at least in lapse of a time corresponding to the time lag after outputting to the driving section a drive signal to move the image sensor from the first position to the second position, and outputs to the driving section a drive signal to move the image sensor to a third position different from the second position between a timing at which the exposure operation ends and a timing which is a time corresponding to the time lag earlier than the end of the exposure operation.

Moving the image sensor during an exposure operation is liable to give rise to an image blur. If the driving section for moving the image sensor has an operation time lag, there is a case that actual driving of the image sensor cannot be realized at the timing of outputting a drive signal to the driving section, even if it is judged that movement of the image sensor has completed, or that the image sensor is ready to move. In view of this, supplying a drive signal to the driving section at the timing considering the operation time lag of the driving section enables to accurately move the image sensor without a time loss. This arrangement enables to execute shift photographing at a high speed.

It may be preferable that a main body of the image sensing apparatus includes a shake detecting section which detects a shake exerted to the apparatus main body; a shake correction amount calculating section which obtains a shake correction amount in a first axis direction and in a second axis direction orthogonal to the first axis direction based on a detection result from the shake detecting section; and an anti-shake controlling section which moves the image sensor on the plane orthogonal to the optical axis in accordance with the shake correction amount obtained by the shake correction amount calculating section in such a direction as to cancel the shake, and the driving section is commonly used as a driving section for the anti-shake controlling section.

In the above arrangement, the shift photographing can be performed by utilizing the driving section in an image-sensor-oscillation type anti-shake mechanism constructed such that anti-shake control of the image sensing apparatus is performed by correctively moving the image sensor on the plane orthogonal to the optical axis. This arrangement enables to reduce the production cost of the image sensing apparatus, because an additional driving section is not required. Also, generally, a high-speed high-precision actuator is used in the anti-shake mechanism. Use of the actuator enables to perform shift photographing in a state that the image sensor is positioned with high-precision.

It may be preferable that the image sensing apparatus is a single lens reflex digital camera including an apparatus main body, and a lens unit detachably attached to the apparatus main body.

The foregoing embodiment adopts an arrangement, in which an image capturing operation is performed by moving the image sensor by the driving section. In this arrangement, an intended shift photographing can be performed in the single lens reflex digital camera irrespective of the kind of the lens unit to be mounted on the apparatus main body, by adjusting the moving amount of the image sensor in conformity to the kind of the lens unit.

It may preferable that the apparatus main body includes a judging section which judges the kind of the lens unit to be detachably attached to the apparatus main body, and the imaging controlling section prohibits the image sensor from moving for creation of the composite image if the judging section judges that the lens unit of a specific kind is attached to the apparatus main body.

There is a case that shift photographing is inappropriate depending on the kind of the lens unit to be attached to the apparatus main body. For instance, shift photographing is improper if a lens unit having an exceedingly small image circle such as an APS-lens unit is mounted. In view of this, movement of the image sensor for creation of the composite image by the imaging controlling section is prohibited if it is detected that such an APS-lens unit is mounted. In this arrangement, since execution of the shift photographing is prohibited depending on the kind of the lens unit to be attached to the apparatus main body, creation of an inappropriate composite image is prevented in advance.

Also, a novel imaging system comprises: an imaging section including an image sensor which converts a subject optical image into an electrical signal; and a driving section which moves the image sensor on a plane orthogonal to an optical axis; an imaging controlling section which causes the image sensor to obtain a first image and a second image, the first image being obtained by causing the image sensor to perform an image capturing operation with the image senor being located at a first position, and the second image being obtained by causing the image sensor to perform an image capturing operation after the image sensor being moved to a second position different from the first position by driving of the driving section; and an image synthesizing section which creates a composite image by joining the first image and the second image.

In the above arrangement, the imaging system comprises the imaging section, the imaging controlling section, and the image synthesizing section. Accordingly, a digital camera or an equivalent device can be utilized as a device incorporated with the imaging section and the imaging controlling section, and a personal computer or an equivalent device can be utilized as a device incorporated with the image synthesizing section. Thus, the imaging system of high flexibility is configured with use of the digital camera or the personal computer.

Further, a novel operation program product is adapted for operating an imaging system provided with an image sensor for converting a subject optical image into an electrical signal, a driving section for moving the image sensor on a plane orthogonal to an optical axis, an imaging controlling section for controlling the image sensor and the driving section to cause the image sensor to perform an image capturing operation, and an image processing section for processing an image acquired by the image capturing operation of the image sensor. The program product comprises a program which allows a computer to execute the steps of making the imaging controlling section to permit the image sensor to obtain a first image by causing the image sensor to perform an image capturing operation with the image sensor being located at a first position, and to permit the image sensor to obtain a second image by causing the image sensor to perform an image capturing operation after the image sensor being moved to a second position different from the first position by driving of the driving section; and making the image processing section to create a composite image by joining the first image and the second image; and a signal bearing media bearing the program.

In the above arrangement, in response to execution of the program, the imaging controlling section is operative to acquire the first image with the image sensor being located at the first position, and subsequently is operative to acquire the second image with the image sensor being located at the second position. Then, in response to execution of the program, the image processing section is operative to create the composite image by joining the first image and the second image.

According to the operation program of the imaging system, provided is a program that enables to cause a predetermined system to perform an image synthesizing operation of joining the first image and the second image.

Another novel operation program product is adapted for operating a processing system provided with an image acquiring section for acquiring image data corresponding to a plurality of frame images, and an image processing section for applying a predetermined image processing to the image data acquired by the image acquiring section. The program product comprises a program which allows a computer to execute the steps of making the image acquiring section acquire a first image by causing an image sensor for converting a subject optical image into an electrical signal to perform an image capturing operation with the image sensor being located at a first position on a plane orthogonal to an optical axis, and a second image by causing the image sensor to perform an image capturing operation after the image sensor being moved to a second position different from the first position; making the image acquiring section acquire information specifying a positional relation between the first image and the second image based on pixel position information; and making the image processing section create a composite image by joining the first image and the second image based on the information specifying the positional relation between the first image and the second image, and a signal bearing media bearing the program.

In the above arrangement, the processing system of the personal computer or the like is functioned as the image acquiring section which acquires the first image and the second image obtained by shift photographing, and the information for specifying the positional relation between the first image and the second image based on the pixel position information of the image sensor, and is functioned as the image processing section which creates the composite image by joining the first image and the second image based on the information for specifying the positional relation.

According to the operation program of the processing system, provided is a program that enables to create a composite image by reading the first image and the second image acquired by shift photographing into the personal computer or the like, and by joining the first image and the second image based on the pixel position information of the image sensor.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image sensing apparatus comprising:
an image sensor which converts a subject optical image into an electrical signal;
a driving section which moves the image sensor on a plane orthogonal to an optical axis of the image sensing apparatus;
an imaging controlling section which causes the image sensor to obtain a first image and a second image, the first image being obtained by causing the image sensor to perform an image capturing operation with the image sensor being located at a first position, and the second image being obtained by causing the image sensor to perform an image capturing operation after the image sensor being moved to a second position different from the first position by driving of the driving section; and
a storage which stores the first image and the second image in correlation to each other so that a composite image is treatable by joining the first image and the second image.

2. The image sensing apparatus according to claim 1, further comprising an image synthesizing section which creates the composite image by joining the first image and the second image.

3. The image sensing apparatus according to claim 2, wherein
the image synthesizing section joins the first image and the second image by specifying a positional relation between the first image and the second image based on pixel position information of the image sensor.

4. The image sensing apparatus according to claim 3, wherein
the image sensor is movable in a first axis direction and in a second axis direction orthogonal to the first axis direction on the plane orthogonal to the optical axis, the image sensing apparatus further comprising,
a moving amount storage which stores information relating to a movable amount of the image sensor relative to a predetermined home position of the image sensor in the first axis direction and in the second axis direction in association with a pixel array number of the image sensor, wherein
the image synthesizing section specifies a shift amount of the second image relative to the first image by calculating a moved amount of the image sensor in the first axis direction and/or the second axis direction by driving of the driving section in terms of the pixel array number of the image sensor based on the information stored in the moving amount storage, and creating the composite image by joining the first image and the second image based on the specified shift amount.

5. The image sensing apparatus according to claim 2, wherein
the image sensor is a rectangular image sensor, and is movable in a first axis direction parallel to a vertical side of the image sensor, and in a second axis direction parallel to a horizontal side of the image sensor on the plane orthogonal to the optical axis,
the imaging controlling section selects a position obtained by moving the image sensor in the first axis direction or in the second axis direction by a certain amount in parallel thereto relative to the first position, as the second position, and causes the image sensor to perform an image capturing operation at the second position to obtain the second image,
the image synthesizing section is so configured as to create the composite image having an aspect ratio different from an aspect ratio of the image sensor by joining the first image and the second image.

6. The image sensing apparatus according to claim 2, wherein
the image synthesizing section includes a selecting section which selects images to be joined among the images obtained by the imaging controlling section.

7. The image sensing apparatus according to claim 6, further comprising a main subject specifying section which specifies the position of a main subject image, wherein
the selecting section selects the images to be joined in such a manner that a joined portion of the images is eliminated from an area in the vicinity of the specified main subject image.

8. The image sensing apparatus according to claim 2, wherein
the image synthesizing section performs a defect pixel interpolation with respect to each of the first image and the second image prior to the joining of the first image and the second image.

9. The image sensing apparatus according to claim 2, further comprising a drive pattern storage which stores a drive pattern according to which the image sensor is moved to predetermined plural positions sequentially according to a predetermined order by the driving section, wherein
the imaging controlling section controls the driving section to move the image sensor to the predetermined positions sequentially based on the drive pattern, and causes the image sensor to perform a series of image capturing operations at the respective positions in response to receiving an operation signal.

10. The image sensing apparatus according to claim 1, wherein in a case that there is a time lag between a timing at which a drive signal is outputted to the driving section and a timing at which the driving section starts movement of the image sensor in response to the drive signal, the imaging controlling section
controls the image sensor to start an exposure operation at least in lapse of a time corresponding to the time lag after outputting to the driving section a drive signal to move the image sensor from the first position to the second position, and
outputs to the driving section a drive signal to move the image sensor to a third position different from the second position between a timing at which the exposure operation ends and a timing which is a time corresponding to the time lag earlier than the end of the exposure operation.

11. The image sensing apparatus according to claim 1, wherein
a main body of the image sensing apparatus includes:
a shake detecting section which detects a shake exerted to the apparatus main body;
a shake correction amount calculating section which obtains a shake correction amount in a first axis direction and in a second axis direction orthogonal to the first axis direction based on a detection result from the shake detecting section; and
an anti-shake controlling section which moves the image sensor on the plane orthogonal to the optical axis in accordance with the shake correction amount obtained by the shake correction amount calculating section in such a direction as to cancel the shake, and
the driving section is commonly used as a driving section for the anti-shake controlling section.

12. The image sensing apparatus according to claim 1, wherein
the image sensing apparatus is a single lens reflex digital camera including an apparatus main body, and a lens unit detachably attached to the apparatus main body.

13. The image sensing apparatus according to claim 12, wherein
the apparatus main body includes a judging section which judges the kind of the lens unit to be detachably attached to the apparatus main body, and
the imaging controlling section prohibits the image sensor from moving for creation of the composite image if the judging section judges that the lens unit of a specific kind is attached to the apparatus main body.

14. An imaging system comprising:
an imaging section including:
an image sensor which converts a subject optical image into an electrical signal; and
a driving section which moves the image sensor on a plane orthogonal to an optical axis;
an imaging controlling section which causes the image sensor to obtain a first image and a second image, the first image being obtained by causing the image sensor to perform an image capturing operation with the image senor being located at a first position, and the second image being obtained by causing the image sensor to perform an image capturing operation after the image sensor being moved to a second position different from the first position by driving of the driving section; and
an image synthesizing section which creates a composite image by joining the first image and the second image.

15. A program product for operating an imaging system provided with an image sensor for converting a subject optical image into an electrical signal, a driving section for moving the image sensor on a plane orthogonal to an optical axis, an imaging controlling section for controlling the image sensor and the driving section to cause the image sensor to perform an image capturing operation, and an image processing section for processing an image acquired by the image capturing operation of the image sensor, the program product comprising:
a program which allows a computer to execute the steps of:
making the imaging controlling section to permit the image sensor to obtain a first image by causing the image sensor to perform an image capturing operation with the image sensor being located at a first position, and to permit the image sensor to obtain a second image by causing the image sensor to perform an image capturing operation after the image sensor being moved to a second position different from the first position by driving of the driving section; and
making the image processing section to create a composite image by joining the first image and the second image; and
a signal bearing media bearing the program.

16. A program product for operating a processing system provided with an image acquiring section for acquiring image data corresponding to a plurality of frame images, and an image processing section for applying a predetermined image processing to the image data acquired by the image acquiring section, the program product comprising:
a program which allows a computer to execute the steps of
making the image acquiring section acquire a first image by causing an image sensor for converting a subject optical image into an electrical signal to perform an image capturing operation with the image sensor being located at a first position on a plane orthogonal to an optical axis, and a second image by causing the image sensor to perform an image capturing operation after the image sensor being moved to a second position different from the first position;
making the image acquiring section acquire information specifying a positional relation between the first image and the second image based on pixel position information, and
making the image processing section create a composite image by joining the first image and the second image based on the information specifying the positional relation between the first image and the second image, and
a signal bearing media bearing the program.
